(19) United States
(12) Patent Application Publication
(10) Pub. No.: US 2023/0381596 A1
(43) Pub. Date: Nov. 30, 2023

(54) GOLF BALL

(71) Applicant: BRIDGESTONE SPORTS CO, LTD., Tokyo (JP)

(72) Inventor: Hideo WATANABE, Chichibushi (JP)

(73) Assignee: BRIDGESTONE SPORTS CO, LTD., Tokyo (JP)

(21) Appl. No.: 18/305,872

(22) Filed: Apr. 24, 2023

(30) Foreign Application Priority Data
May 26, 2022 (JP) 2022-086059

(51) Int. Cl. A63B 37/00; C08K 3/30; C08K 5/098; C08K 5/14

(52) U.S. Cl. CPC A63B 37/0075; A63B 37/0063; A63B 37/009; A63B 37/0096; C08K 5/14; A63B 37/0051; A63B 37/0082; C08K 3/30; C08K 5/098; A63B 37/00922

(57) ABSTRACT

A golf ball having a single-layer rubber core, a single-layer resin cover and one intermediate layer therebetween satisfies the following conditions:

(Shore C hardness at surface of intermediate layer-encased sphere)>(Shore C hardness at ball surface),

14≤(Atti compression of core)≤38,

(Atti compression of core)/(Shore C hardness at core surface−Shore C hardness at core center)≤1.1, and

600≤(Shore C hardness at surface of intermediate layer-encased sphere)×(specific gravity of intermediate layer material)×[volume (cm³) of intermediate layer material].

This ball has a superior distance performance on full shots with an iron and a high spin performance in the short game, imparts a very soft feel and possesses an excellent durability to cracking on repeated impact. The ball is intended to satisfy the needs of primarily skilled amateur golfers who handle iron shots skillfully.

### CROSS-REFERENCE TO RELATED APPLICATIONS

This non-provisional application claims priority under 35 U.S.C. § 119(a) on Patent Application No. 2022-086059 filed in Japan on May 26, 2022, the entire contents of which are hereby incorporated by reference.

### TECHNICAL FIELD

The present invention relates to a golf ball with a three-piece construction having a single-layer core, a single-layer cover and one intermediate layer interposed therebetween. The invention relates more particularly to a golf ball which satisfies the needs of skilled amateur golfers.

### BACKGROUND ART

Among amateur golfers, there exist many high-level players who skillfully handle iron shots. Achieving a superior distance on full shots not only with a driver (W #1), but also with long and middle irons, is an important element in playing golf. The needs of most skilled amateur golfers can be fully satisfied by, in addition to endowing a golf ball with a superior distance on full shots with an iron, also providing the golf ball with a high spin performance in the short game, a very soft feel at impact and an excellent durability to repeated impact.

JP-A 2011-120898, JP-A 2016-112308, JP-A 2017-000183, JP-A 2017-000470, JP-A 2018-183247 and JP-A 2020-175021 disclose three-piece golf balls which are so-called spin balls in which the intermediate layer is harder than the cover and the cover layer is formed primarily of polyurethane. However, even the golf balls described in this patent literature fall short in terms of satisfying all of the above qualities: distance on full shots with an iron, feel, and durability to repeated impact.

### SUMMARY OF THE INVENTION

It is therefore an object of the present invention to provide a golf ball which exhibits a superior distance performance on full shots with an iron and a high spin performance in the short game, and which moreover has both a very soft feel and an excellent durability to cracking on repeated impact.

As a result of intensive investigations, we have found that, in a golf ball having a single-layer rubber core, a single-layer resin cover and one intermediate layer interposed between the core and the cover, certain advantageous effects can be obtained by constructing the golf ball such that the surface hardness relationship between the sphere obtained by encasing the core with the intermediate layer (intermediate layer-encased sphere) and the ball satisfies the condition:

(surface hardness of intermediate layer-encased sphere)>(surface hardness of ball),

and also such as to satisfy the following three formulas:

14≤(Atti compression of core)≤38,

(Atti compression of core)/(Shore C hardness at core surface−Shore C hardness at core center)≤1.1, and

600≤(Shore C hardness at surface of intermediate layer-encased sphere)×(specific gravity of intermediate layer material)×[volume (cm³) of intermediate layer material].

Namely, such a golf ball construction enables primarily skilled amateur golfers who handle iron shots skillfully to achieve a superior distance performance on full shots with an iron and imparts the ball with a high spin performance in the short game, in addition to which the ball has a very soft feel and an excellent durability to cracking on repeated impact.

The golf ball of the invention is thus a ball which satisfies the needs of the skilled amateur golfer by having a relatively soft cover that enables a high level of spin control in the short game, a hard intermediate layer that keeps the ball from being too receptive to spin on full shots with an iron, and a core with a hardness profile that provides a very soft feel and an excellent durability to cracking on repeated impact.

In this Specification, a “skilled amateur golfer” refers to a golfer having a head speed on shots with a number six iron in the range of generally 35 to 45 m/s and a handicap of generally 12 or less.

Accordingly, the invention provides a golf ball having a single-layer rubber core, a single-layer resin cover and one intermediate layer interposed between the core and the cover, wherein the sphere obtained by encasing the core with the intermediate layer (intermediate layer-encased sphere) and the ball have a surface hardness relationship therebetween which satisfies the condition:

(Shore C hardness at surface of intermediate layer-encased sphere)>(Shore C hardness at surface of ball);
and the ball satisfies the following three conditions:

14≤(Atti compression of core)≤38,

(Atti compression of core)/(Shore C hardness at core surface−Shore C hardness at core center)≤1.1, and

600≤(Shore C hardness at surface of intermediate layer-encased sphere)×(specific gravity of intermediate layer material)×[volume (cm³) of intermediate layer material].

In a preferred embodiment of the golf ball of the invention, the ball has a core hardness profile which, letting H100 be the Shore C hardness at the core surface, H87.5 be the Shore C hardness at a position 87.5% of the core radius outward from the core center, H75 be the Shore C hardness at a position 75% of the core radius outward from the core center, H50 be the Shore C hardness at a position 50% of the core radius outward from the core center, and H0 be the Shore C hardness at the core center, satisfies the condition:

(H100−H0)≤24.

In this preferred embodiment, the core hardness profile may satisfy the condition:

(H100−H0)/(H50−H0)≥3.0.

In the same preferred embodiment, the core hardness profile may alternatively or additionally satisfy the condition:

(H87.5−H75)−(H100−H87.5)≥−0.5.

In another preferred embodiment, the core is a material molded under heat from a rubber composition which includes (A) a base rubber, (B) an organic peroxide, (C) water and/or a metal monocarboxylate, and (D) sulfur.

In this preferred embodiment, components (C) and (D) may have a weight ratio (D)/(C) therebetween which is from 0.010 to 0.200.

In yet another further preferred embodiment, the ball satisfies the following three conditions:

−0.10≤(specific gravity of core)−(specific gravity of intermediate layer material)≤0.10

−0.10≤(specific gravity of cover material)−(specific gravity of intermediate layer material)≤0.10

−0.10(specific gravity of core)−(specific gravity of cover material)≤0.10

In still another preferred embodiment, the specific gravity of the intermediate layer material is 1.05 or more.

In a further preferred embodiment, the intermediate layer material includes a granular inorganic filler.

In a still further preferred embodiment, the ball satisfies the condition: (Shore C hardness at surface of intermediate layer-encased sphere)/{(Shore C hardness at core surface−Shore C hardness at core center)×intermediate layer thickness (mm)}≤2.7.

In another preferred embodiment, letting CL1 be the coefficient of lift measured at a Reynolds number of 80,000 and a spin rate of 2,000 rpm and CL2 be the coefficient of lift measured at a Reynolds number of 70,000 and a spin rate of 1,900, CL1 and CL2 satisfy the condition:

0.950≤CL2/CL1.

In yet another preferred embodiment, letting CL3 be the coefficient of lift measured at a Reynolds number of 200,000 and a spin rate of 2,500 rpm and CL4 be the coefficient of lift measured at a Reynolds number of 120,000 and a spin rate of 2,250, CL3 and CL4 satisfy the condition:

1.250≤CL4/CL3≤1.300.

### Advantageous Effects of the Invention

The golf ball of the invention has a superior distance performance on full shots with an iron and a high spin performance in the short game, in addition to which it provides a very soft feel at impact and has an excellent durability to cracking on repeated impact, and is intended in particular to satisfy the needs of primarily skilled amateur golfers who handle iron shots skillfully.

### BRIEF DESCRIPTION OF THE DRAWINGS

FIG. 1 is a schematic cross-sectional view of the golf ball according to one embodiment of the invention.

FIG. 2A is a plan view and FIG. 2B is a side view showing the Type A dimple pattern used in the Examples and the Comparative Examples.

FIG. 3A is a plan view and FIG. 3B is a side view showing the Type B dimple pattern used in the Examples and the Comparative Examples.

FIG. 4 is a graph showing the core hardness profiles in Examples 1 to 6.

FIG. 5 is a graph showing the core hardness profiles in Comparative Examples 1 to 7.

### DETAILED DESCRIPTION OF THE INVENTION

The objects, features and advantages of the invention will become more apparent from the following detailed description taken in conjunction with the appended diagrams.

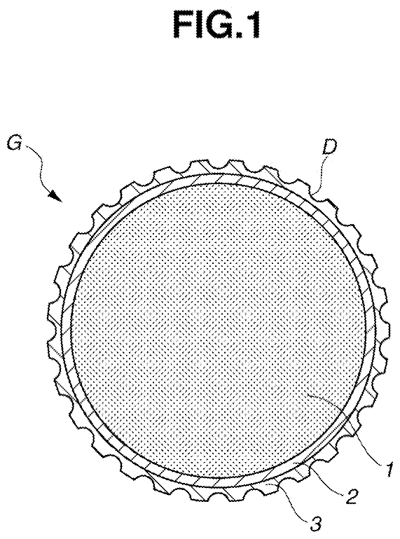

The golf ball of the invention has a single-layer core, an intermediate layer and a single-layer cover. FIG. 1 shows an example of the inventive golf ball. The golf ball G shown in FIG. 1 has a single-layer core 1, a single intermediate layer 2 encasing the core 1, and a single-layer cover 3 encasing the intermediate layer. The cover 3 is positioned as the outermost layer, excluding a coating layer, in the layered construction of the ball. As shown in FIG. 1, the intermediate layer 2 is formed as a single layer. Numerous dimples D are typically formed on the surface of the cover (outermost layer) 3 in order to enhance the aerodynamic properties of the ball. Although not shown in FIG. 1, a coating layer is generally formed on the surface of the cover 3. The layers are each described in detail below.

The core is composed primarily of a rubber material. Specifically, a core-forming rubber composition can be prepared by using a base rubber as the chief component and also including other ingredients such as a co-crosslinking agent, an organic peroxide, an inert filler and an organosulfur compound.

The core used in this invention is preferably a material molded under heat from a rubber composition which includes components (A) to (D) below:
(A) a base rubber,
(B) an organic peroxide,
(C) water and/or a metal monocarboxylate, and
(D) sulfur.

It is preferable to use polybutadiene as the base rubber (A). Commercial products may be used as the polybutadiene. Illustrative examples include BR01, BR51, BR730 and T0700 (all from JSR Corporation). The proportion of polybutadiene within the base rubber is preferably at least 60 wt %, and more preferably at least 80 wt %. Rubber ingredients other than the above polybutadienes may be included in the base rubber, provided that doing so does not detract from the advantageous effects of the invention. Examples of rubber ingredients other than the above polybutadienes include other polybutadienes and also other diene rubbers, such as styrene-butadiene rubbers, natural rubbers, isoprene rubbers and ethylene-propylene-diene rubbers.

It is suitable to use an organic peroxide having a relatively high thermal decomposition temperature as the organic peroxide (B). Organic peroxides having a high one-minute half-life temperature of between about 165° C. and about 185° C., such as dialkyl peroxides, may be used. Examples of dialkyl peroxides that may be suitably used include dicumyl peroxide (Percumyl D, from NOF Corporation), 2,5-dimethyl-2,5-di(t-butylperoxy)hexane (Perhexa 25B, from NOF Corporation) and di(2-t-butylperoxyisopropyl)benzene (Perbutyl P, from NOF Corporation). Preferred use can be made of dicumyl peroxide. These organic peroxides may be used singly or two or more may be used together. The half-life is one indicator representing the magnitude of the decomposition rate by the organic peroxide, and is expressed as the time required for the original organic peroxide to decompose and the amount of active oxygen therein to fall to one-half. The vulcanization temperature in the core-forming rubber composition is generally in the range of between 120° C. and 190° C.; within this range, an organic peroxide having a high one-minute half-life temperature of between about 165° C. and about 185° C. undergoes relatively slow thermal decomposition. When the above rubber composition is used in this invention, the core as a crosslinked rubber product having the subsequently described specific internal hardness profile can be obtained by adjusting the amount of free radicals generated, which amount increases as the vulcanization time elapses.

The water (C) is not particularly limited, and may be distilled water or tap water. The use of distilled water that is free of impurities is especially suitable. The amount of water included per 100 parts by weight of the base rubber is preferably at least 0.1 part by weight, and more preferably at least 0.2 part by weight. The upper limit is preferably not more than 2 parts by weight, and more preferably not more than 1 part by weight.

Decomposition of the organic peroxide within the core formulation can be promoted by the direct addition of water or a water-containing material as component (C) to the core material. The decomposition efficiency of the organic peroxide within the core-forming rubber composition is known to change with temperature; starting at a given temperature, the decomposition efficiency rises with increasing temperature. If the temperature is too high, the amount of decomposed radicals rises excessively, leading to recombination between radicals and, ultimately, deactivation. As a result, fewer radicals act effectively in crosslinking. Here, when a heat of decomposition is generated by decomposition of the organic peroxide at the time of core vulcanization, the vicinity of the core surface remains at substantially the same temperature as the temperature of the vulcanization mold, but the temperature near the core center, due to the build-up of heat of decomposition by the organic peroxide which has decomposed from the outside, becomes considerably higher than the mold temperature. In cases where water or a water-containing material is added directly to the core, because the water acts to promote decomposition of the organic peroxide, radical reactions like those described above can be made to differ at the core center and core surface. That is, decomposition of the organic peroxide is further promoted near the center of the core, bringing about greater radical deactivation, which leads to a further decrease in the amount of active radicals. As a result, it is possible to obtain a core in which the crosslink densities at the core center and the core surface differ markedly. It is also possible to obtain a core having different dynamic viscoelastic properties at the core center.

A metal monocarboxylate may be used instead of the above water. In a metal monocarboxylate, the carboxylic acid is assumed to be coordination bonded to the metal atom, which differentiates such compounds from metal dicarboxylates such as zinc diacrylate of the chemical formula [CH2═CHCOO]₂Zn. Because a metal monocarboxylate furnishes the rubber composition with water by way of a dehydrative condensation reaction, an effect similar to that of water can be obtained. Also, a metal monocarboxylate can be included in the rubber composition as a powder, which enables the operations to be simplified and makes uniform dispersion within the rubber composition easy. Effectively carrying out this reaction requires the use of a monosalt. The amount of metal monocarboxylate included per 100 parts by weight of the base rubber is preferably at least 1 part by weight, and more preferably at least 3 parts by weight. The upper limit is preferably not more than 60 parts by weight, and more preferably not more than 50 parts by weight. When too little metal monocarboxylate is included, it may be difficult to obtain a suitable crosslink density, which may make it impossible to obtain a sufficient golf ball spin rate-lowering effect. On the other hand, when too much is included, the core becomes too hard, as a result of which it may be difficult to retain a suitable feel at impact.

Examples of carboxylic acids that may be used include acrylic acid, methacrylic acid, maleic acid, fumaric acid and stearic acid. Examples of the substituting metal include Na, K, Li, Zn, Cu, Mg, Ca, Co, Ni and Pb. Preferred use can be made of Zn. Specific examples of the metal monocarboxylate include zinc monoacrylate and zinc monomethacrylate. The use of zinc monoacrylate is especially preferred.

Specific examples of the sulfur (D) include those available under the trade names Sanmix S-80N (from Sanshin Chemical Industry Co., Ltd.) and Sulfax-5 (Tsurumi Chemical Industry Co., Ltd.). The amount of sulfur included per 100 parts by weight of the base rubber is more than 0 parts by weight, preferably at least 0.005 part by weight, and more preferably at least 0.01 part by weight. Although there is no upper limit in the amount included, the amount is preferably set to not more than 0.1 part by weight, more preferably not more than 0.05 part by weight, and even more preferably not more than 0.04 part by weight. Adding sulfur makes it possible to increase hardness differences in the core. However, including too much sulfur may result in a large decline in the rebound or a decrease in the durability to repeated impact.

The ratio in which components (C) and (D) are included, expressed as the weight ratio (D)/(C), is preferably at least 0.010, more preferably at least 0.013, and even more preferably at least 0.016. The upper limit is preferably not more than 0.200, more preferably not more than 0.100, and even more preferably not more than 0.060. Outside of this numerical range, it may be difficult to achieve the intended core hardness profile and it may be impossible to achieve both a superior distance due to a reduced spin rate on full shots and also a good durability to repeated impact. It should be noted that the amount of component (D) refers not to the weight of the sulfur product itself, but to the weight of the sulfur constituent included within the product.

In addition to above components (A) to (D), the rubber composition may also include (E) a co-crosslinking agent and (F) an inert filler. Where necessary, an antioxidant and an organic sulfur compound may also be added. These ingredients are described in detail below.

Examples of the co-crosslinking agent (E) include unsaturated carboxylic acids and

the metal salts of unsaturated carboxylic acids. Specific examples of unsaturated carboxylic acids include acrylic acid, methacrylic acid, maleic acid and fumaric acid. The use of acrylic acid or methacrylic acid is especially preferred. Exemplary metal salts of unsaturated carboxylic acids include, without particular limitation, the above unsaturated carboxylic acids that have been neutralized with desired metal ions. Specific examples include the zinc salts and magnesium salts of methacrylic acid and acrylic acid. The use of zinc acrylate is especially preferred.

The unsaturated carboxylic acid and/or metal salt thereof is included in an amount, per 100 parts by weight of the base rubber, which is generally at least 5 parts by weight, preferably at least 9 parts by weight, and more preferably at least 13 parts by weight. The upper limit is generally not more than 60 parts by weight, preferably not more than 50 parts by weight, and more preferably not more than 40 parts by weight. Too much may make the core too hard, giving the ball an unpleasant feel at impact, whereas too little may lower the rebound.

Examples of the inert filler (F) that may be suitably used include zinc oxide, barium sulfate and calcium carbonate. One of these may be used alone, or two or more may be used together. The amount of inert filler included per 100 parts by weight of the base rubber is preferably at least 1 part by weight, and more preferably at least 5 parts by weight. The upper limit is preferably not more than 30 parts by weight, more preferably not more than 25 parts by weight, and even more preferably not more than 20 parts by weight. The inert filler content is adjusted in order to adjust the specific gravity of the core; too little inert filler may make it impossible to obtain a proper ball weight and a suitable rebound.

In addition, an antioxidant may be optionally included. Illustrative examples of suitable commercial antioxidants include Nocrac MB, Nocrac NS-6 and Nocrac NS-30 (all available from Ouchi Shinko Chemical Industry Co., Ltd.), and Yoshinox 425 (available from Yoshitomi Pharmaceutical Industries, Ltd.). One of these may be used alone, or two or more may be used together.

The amount of antioxidant included per 100 parts by weight of the base rubber is set to preferably 0 part by weight or more, more preferably at least 0.05 part by weight, and even more preferably at least 0.1 part by weight. The upper limit is set to preferably not more than 3 parts by weight, more preferably not more than 2 parts by weight, even more preferably not more than 1 part by weight, and most preferably not more than 0.5 part by weight. Too much or too little antioxidant may make it impossible to achieve a suitable ball rebound and durability.

An organosulfur compound may be included in the core in order to impart a good resilience. The organosulfur compound is not particularly limited, provided that it can enhance the rebound of the golf ball. Exemplary organosulfur compounds include thiophenols, thionaphthols, halogenated thiophenols, and metal salts of these. Specific examples include pentachlorothiophenol, pentafluorothiophenol, pentabromothiophenol, p-chlorothiophenol, the zinc salt of pentachlorothiophenol, the zinc salt of pentafluorothiophenol, the zinc salt of pentabromothiophenol, the zinc salt of p-chlorothiophenol, and any of the following having 2 to 4 sulfur atoms: diphenylpolysulfides, dibenzylpolysulfides, dibenzoylpolysulfides, dibenzothiazoylpolysulfides and dithiobenzoylpolysulfides. The use of the zinc salt of pentachlorothiophenol is especially preferred.

It is recommended that the amount of organosulfur compound included per 100 parts by weight of the base rubber be preferably 0 part by weight or more, more preferably at least part by weight, and even more preferably at least 0.1 part by weight, and that the upper limit be preferably not more than 5 parts by weight, more preferably not more than 3 parts by weight, and even more preferably not more than 2.5 parts by weight. Including too much organosulfur compound may make a greater rebound-improving effect (particularly on shots with a W #1) unlikely to be obtained, may make the core too soft or may worsen the feel of the ball at impact. On the other hand, including too little may make a rebound-improving effect unlikely.

The core can be produced by vulcanizing and curing the rubber composition containing the above ingredients. For example, the core can be produced by using a Banbury mixer, roll mill or other mixing apparatus to intensively mix the rubber composition, subsequently compression molding or injection molding the mixture in a core mold, and curing the resulting molded body by suitably heating it under conditions sufficient to allow the organic peroxide or co-crosslinking agent to act, such as at a temperature of between 100 and 200° C., preferably between 140 and 180° C., for 10 to 40 minutes.

In this invention, the core is formed as a single layer. In a multi-layer rubber core, separation at the interface may arise with repeated impact, worsening the durability.

The core diameter, although not particularly limited, is preferably at least 37.1 mm, more preferably at least 37.5 mm, and even more preferably at least 37.9 mm. The upper limit is preferably not more than 39.7 mm, more preferably not more than 39.1, and even more preferably not more than 38.7 mm. When the core diameter is too small, the initial velocity on full shots may decrease and the intended distance may not be achieved, or the feel at impact may become too hard. On the other hand, when the core diameter is too large, the durability to cracking on repeated impact may worsen or the spin rate on full shots may rise and the intended distance may not be achieved.

The core has a specific gravity which, although not particularly limited, is preferably at least 1.03, more preferably at least 1.06, and even more preferably at least 1.09. The specific gravity is preferably not more than 1.23, more preferably not more than 1.20, and even more preferably not more than 1.17. When the core specific gravity is too small, the added amount of filler in the rubber composition becomes low and molding the ball to the desired Atti compression may be difficult. On the other hand, when the core specific gravity is too large, the added amount of filler in the rubber composition becomes high and the rebound decreases, as a result of which it may not be possible to achieve the desired distance.

The core has an Atti compression which, although not particularly limited, is preferably at least 14, more preferably at least 15, and even more preferably at least 17. The Atti compression is preferably not more than 38, more preferably not more than 34, and even more preferably not more than 30. When this core compression value is too large, the spin rate, particularly on full shots with an iron, may become too high, as a result of which a good distance may not be achieved, or the feel of the ball on impact may become too hard. On the other hand, when the Atti compression of the core is too small, the feel may become too soft or the durability to cracking on repeated impact may worsen. Atti compression has been widely used in the golf ball industry since the 1940s. Compression measured using the same apparatus and method is also called “PGA compression.” The Atti compression is a numerical value which expresses in kilogram units the compressive load required for the ball (or core) to deflect 0.1 inch (2.54 mm). The smallest value on the scale is 0. Commercial golf balls fall within a value range of up to about 140. The Atti compression is measured with an Atti compression tester from Atti Engineering Corporation. The tester is designed to measure spherical specimens having a diameter of 42.7 mm (1.68 inches). When measuring the compression of a core, because the core has a small diameter, measurement is carried out after inserting a spacer shim between the plunger and the core such as to bring the (core diameter+shim thickness) up to 42.7 mm.

It is critical for the core used in the invention to satisfy the following condition:

(Atti compression of core)/(Shore C hardness at core surface−Shore C hardness at core center)≤1.1.

When this indicator is small, it means that the core compression (Atti) is small and also that a core surface/center hardness difference in the large direction is suppressed. When this indicator is large, it means that the core compression (Atti) is large and also that a core surface/center hardness difference in the small direction is suppressed. Specifically, the (core Atti compression)/(Shore C hardness at core surface−Shore C hardness at core center) value is preferably at least 0.5, more preferably at least 0.6, and even more preferably at least 0.7. The upper limit is 1.1 or less, preferably 1.0 or less, and more preferably 0.9 or less. When this value is too large, the spin rate on full shots rises and a good distance is not achieved, or the feel at impact becomes too hard. On the other hand, when this value is too small, the durability to cracking on repeated impact may worsen or the feel at impact may become too soft.

Next, the hardness profile of the core is described. The core hardnesses explained below are Shore C hardnesses. These are hardness values measured with a Shore C durometer in accordance with ASTM D2240.

In the following explanation of the core hardness profile, H100 is defined as the Shore C hardness at the core surface, H87.5 as the Shore C hardness at a position 87.5% of the core radius outward from the core center, H75 as the Shore C hardness at a position 75% of the core radius outward from the core center, H62.5 as the Shore C hardness at a position 62.5% of the core radius outward from the core center, H50 as the Shore C hardness at a position 50% of the core radius outward from the core center, H37.5 as the Shore C hardness at a position 37.5% of the core radius outward from the core center, H25 as the Shore C hardness at a position 25% of the core radius outward from the core center, H12.5 as the Shore C hardness at a position 12.5% of the core radius outward from the core center and H0 as the Shore C hardness at the core center.

The surface hardness of the core (H100), although not particularly limited, is preferably at least 75, more preferably at least 77, and even more preferably at least 79, and is preferably not more than 91, more preferably not more than 89, and even more preferably not more than 87. When this value is too small, the rebound may decrease and the flight performance may worsen, or the durability of the ball to cracking on repeated impact may worsen. On the other hand, when this value is too large, the feel of the ball may become harder, or the spin rate on full shots may rise, as a result of which the intended distance may not be obtained.

The hardness at a position 87.5% of the core radius outward from the core center (H87.5), although not particularly limited, is preferably at least 71, more preferably at least 73, and even more preferably at least 75, and is preferably not more than 84, more preferably not more than 82, and even more preferably not more than 80. A value outside of this range may lead to disadvantageous results similar to those described above for the core surface hardness (H100).

The hardness at a position 75% of the core radius outward from the core center (H75), although not particularly limited, is preferably at least 65, more preferably at least 67, and even more preferably at least 69, and is preferably not more than 76, more preferably not more than 74, and even more preferably not more than 72. A value outside of this range may lead to disadvantageous results similar to those described above for the core surface hardness (H100).

The hardness at a position 50% of the core radius outward from the core center (H50), although not particularly limited, is preferably at least 55, more preferably at least 57, and even more preferably at least 59, and is preferably not more than 68, more preferably not more than 66, and even more preferably not more than 64. A value outside of this range may lead to disadvantageous results similar to those described above for the core surface hardness (H100).

The hardness at the core center (H0), although not particularly limited, is preferably at least 49, more preferably at least 51, and even more preferably at least 53, and is preferably not more than 61, more preferably not more than 59, and even more preferably not more than 57. A value outside of this range may lead to disadvantageous results similar to those described above for the core surface hardness (H100).

The hardness difference between the core surface and center, that is, the value of (H100−H0), is preferably at least 24, more preferably at least 26, and even more preferably at least 28. The upper limit is preferably not more than 35, more preferably not more than 33, and even more preferably not more than 31. When this value is too large, the initial velocity of the ball when struck on a full shot may become low and a good distance may not be achieved, or the durability to cracking on repeated impact may worsen. On the other hand, when this value is too small, the spin rate-lowering effect on full shots may be inadequate and a good distance may not be achieved.

The core used in this invention preferably satisfies the following condition: (H100−H0)/(H50−H0)≥3.0

This expression means that the hardness gradient from the core center to the core surface is larger than the hardness gradient from the core center to the midpoint. Specifically, the value (H100−H0)/(H50−H0) is preferably at least 3.0, more preferably at least 3.2, and even more preferably at least 3.4. The upper limit is preferably not more than 7.0, more preferably not more than 6.0, and even more preferably not more than 5.6. When this value is too small, the spin rate-lowering effect on full shots may be inadequate and a good distance may not be achieved. On the other hand, when this value is too large, the initial velocity on shots may become low and a good distance may not be achieved, or the durability to cracking on repeated impact may worsen.

Also, the core used in this invention preferably satisfies the following condition:

(H87.5−H75)−(H100−H87.5)≥−0.5

This expression means that the hardness gradient from a position 87.5% of the core radius outward from the core center to the core surface does not become too steep relative to the hardness gradient from a position 75% of the core radius outward from the core center to a position 87.5% outward from the core center. Specifically, the value (H87.5−H75)−(H100−H87.5) is preferably equal to or more than −0.5, more preferably equal to or more than 0.5, and even more preferably equal to or more than 0.8. The upper limit is preferably not more than 4.5, more preferably not more than 4.0, and even more preferably not more than 3.6.

Next, the intermediate layer is described. The intermediate layer is formed as a single layer. As explained below, it is preferable for this layer to be formed of a resin material.

The intermediate layer has a material hardness on the Shore D hardness scale which,

although not particularly limited, is preferably at least 60, more preferably at least 62, and even more preferably at least 64. The material hardness is preferably not more than 72, more preferably not more than 70, and even more preferably not more than 68. The surface hardness of the sphere obtained by encasing the core with the intermediate layer (intermediate layer-encased sphere), expressed on the Shore D hardness scale, is preferably at least 66, more preferably at least 68, and even more preferably at least 70. The upper limit is preferably not more than 78, more preferably not more than 76, and even more preferably not more than 74. When the material hardness and surface hardness of the intermediate layer are lower than the above ranges, the spin rate of the ball on full shots may rise excessively and a good distance may not be achieved, or the initial velocity of the ball may decrease, as a result of which a good distance may not be achieved on full shots. On the other hand, when the material hardness and surface hardness are too high, the durability to cracking on repeated impact may worsen or the feel may worsen.

The intermediate layer has a material hardness on the Shore C hardness scale which is preferably at least 88, more preferably at least 89, and even more preferably at least 92. The upper limit is preferably not more than 98, more preferably not more than 96, and even more preferably not more than 94. The intermediate layer-encased sphere has a surface hardness on the Shore C hardness scale which is preferably at least 92, more preferably at least 94, and even more preferably at least 96. The upper limit is preferably not more than 100, more preferably not more than 99, and even more preferably not more than 98.

The intermediate layer has a thickness which is preferably at least 0.9 mm, more preferably at least 1.2 mm, and even more preferably at least 1.4 mm. The upper limit is preferably not more than 2.0 mm, more preferably not more than 1.8 mm, and even more preferably not more than 1.6 mm. When the intermediate layer is too thin, the durability to cracking on repeated impact may worsen, or the spin rate on full shots with an iron may rise and a good distance may not be achieved. On the other hand, when the intermediate layer is too thick, the initial velocity on shots may decrease and the intended distance may not be achieved, or the feel may worsen.

Various thermoplastic resins used as golf ball materials, particularly resin materials composed primarily of an ionomer resin, can be employed as the intermediate layer material. By using an ionomer resin as the intermediate layer material, a lower spin rate and a higher rebound are both achieved on full shots with a driver (W #1) by a golfer whose head speed is not fast, enabling the intended distance to be achieved, in addition to which a good durability to cracking on repeated impact can be ensured.

A granular inorganic filler may be included in the intermediate layer material. The granular inorganic filler is an ingredient which is included in order to adjust the specific gravity and also as a reinforcement. Although not particularly limited, zinc oxide, barium sulfate, titanium dioxide and the like may be suitably used. Barium sulfate is preferred because the advantageous effect of enhancing the durability of the ball to cracking on repeated impact is large; precipitated barium sulfate is more preferred.

The granular inorganic filler has a mean particle size which, although not particularly limited, may be set to preferably from 0.01 to 100 μm, and more preferably from 0.1 to 10 μm. When the mean particle size of the granular inorganic filler is too small or too large, the dispersibility during preparation of the intermediate layer material may worsen. As used herein, “mean particle size” refers to the particle size obtained by dispersing the granular inorganic filler in an aqueous solution together with a suitable dispersant, and carrying out measurement with a particle size analyzer.

The granular inorganic filler is included in an amount, per 100 parts by weight of the base resin of the intermediate layer material, which is generally more than 0 part by weight, preferably at least 10 parts by weight, and more preferably at least 15 parts by weight. The upper limit is generally not more than 50 parts by weight, preferably not more than 40 parts by weight, and more preferably not more than 30 parts by weight. When this content is too low, the durability to cracking on repeated impact may worsen. On the other hand, when this content is too high, the ball rebound may become too low and a good distance may not be achieved.

Depending on the intended use of the ball, optional additives may be suitably included in the intermediate layer material. For example, pigments, dispersants, antioxidants, ultraviolet absorbers and light stabilizers may be included. When these additives are included, the amount added per 100 parts by weight of the base resin is preferably at least 0.1 part by weight, and more preferably at least 0.5 part by weight. The upper limit is preferably not more than 10 parts by weight, and more preferably not more than 4 parts by weight.

It is desirable to abrade the surface of the intermediate layer in order to increase adhesion of the intermediate layer material with the polyurethane that is used in the subsequently described cover material. In addition, it is desirable to apply a primer (adhesive) to the surface of the intermediate layer following such abrasion treatment or to add an adhesion reinforcing agent to the intermediate layer material.

The intermediate layer material has a specific gravity which, although not particularly limited, is preferably at least 0.90, more preferably at least 1.00, and even more preferably at least 1.05. The specific gravity is preferably not more than 1.20, more preferably not more than 1.15, and even more preferably not more than 1.10. When the specific gravity of the intermediate layer is too low, the durability to cracking on repeated impact may worsen. On the other hand, when the specific gravity of the intermediate layer is too high, the rebound may become too low, as a result of which a good distance may not be achieved.

The volume of the intermediate layer is not particularly limited, although it is preferably at least 6.5 cm³, more preferably at least 6.9 cm³, and even more preferably at least 7.2 cm³. The volume is preferably not more than 8.0 cm³, more preferably not more than 7.8 cm³, and even more preferably not more than 7.6 cm³. When this value is small, the durability to cracking on repeated impact may worsen or the spin rate of the ball on full shots with an iron may rise and a good distance may not be achieved. On the other hand, when this value is large, the initial velocity on shots may become low, as a result of which a good distance may not be achieved, or the feel of the ball at impact may worsen.

The value of (Shore C hardness at surface of intermediate layer-encased sphere)×(specific gravity of intermediate layer material)×[volume (cm³) of intermediate layer material] is preferably at least 600, more preferably at least 630, and even more preferably at least 660. The upper limit is preferably not more than 850, more preferably not more than 820, and even more preferably not more than 800. A large value means that the intermediate layer is hard, the specific gravity is high and the volume is not small. When this value falls outside of the above range, a superior distance performance on full shots with an iron and excellent durability to cracking on repeated impact cannot both be achieved at the same time. Next, the cover which serves as the outermost layer is described.

The cover has a material hardness on the Shore D hardness scale which, although not particularly limited, is preferably at least 35, more preferably at least 40, and even more preferably at least 43. The material hardness is preferably not more than 60, more preferably not more than 55, and even more preferably not more than 50. The surface hardness of the sphere obtained by encasing the intermediate layer-encased sphere with the cover (i.e., the ball surface hardness), expressed on the Shore D hardness scale, is preferably at least 50, more preferably at least 53, and even more preferably at least 56. The upper limit is preferably not more than 70, more preferably not more than 67, and even more preferably not more than 64. When the material hardness of the cover and the ball surface hardness are lower than the respective above ranges, the spin rate of the ball on full shots with an iron may rise and a good distance may not be achieved under any hitting conditions. On the other hand, when the material hardness of the cover and the ball surface hardness are higher than the above ranges, the ball may not be sufficiently receptive to spin on approach shots or the scuff resistance may worsen.

The cover has a material hardness on the Shore C hardness scale which is preferably at least 57, more preferably at least 63, and even more preferably at least 67. The upper limit is preferably not more than 89, more preferably not more than 83, and even more preferably not more than 76. The surface hardness of the ball on the Shore C hardness scale is preferably at least 75, more preferably at least 80, and even more preferably at least 84. The upper limit is preferably not more than 95, more preferably not more than 92, and even more preferably not more than 90.

The cover has a thickness of preferably at least 0.3 mm, more preferably at least 0.45 mm, and even more preferably at least 0.6 mm. The upper limit in the cover thickness is preferably not more than 1.2 mm, more preferably not more than 1.15 mm, and even more preferably not more than 1.0 mm. When the cover is too thick, the rebound on full shots with an iron may be inadequate or the spin rate may rise, as a result of which a good distance may not be achieved. On the other hand, when the cover is too thin, the scuff resistance may worsen or the ball may not be fully receptive to spin on approach shots and may thus lack sufficient controllability.

The combined thickness of the cover and the intermediate layer is preferably at least 1.5 mm, more preferably at least 1.8 mm, and even more preferably at least 2.0 mm. The upper limit of this combined thickness is preferably not more than 2.8 mm, more preferably not more than 2.6 mm, and even more preferably not more than 2.4 mm. When the combined thickness is too small, the durability of the ball to cracking on repeated impact may worsen or the feel at impact may worsen. On the other hand, when the combined thickness is too large, the initial velocity on full shots may decline and a good distance may not be achieved.

The cover has a specific gravity which, although not particularly limited, is preferably at least 1.00, more preferably at least 1.03, and even more preferably at least 1.06. The specific gravity is preferably not more than 1.20, more preferably not more than 1.17, and even more preferably not more than 1.14. When the specific gravity of the cover is lower than the above range, the proportion in which a low-specific-gravity material such as an ionomer is blended in the urethane serving as the chief material of the cover ends up being high, as a result of which the scuff resistance may worsen. On the other hand, when the cover specific gravity is too high, the amount of filler added becomes large, as a result of which the rebound may become too low and the desired distance may be unattainable.

Various types of thermoplastic resins used in golf ball cover stock may be employed as the cover material. For reasons having to do with spin controllability in the short game and scuff resistance, the use of a resin material made up largely of a thermoplastic polyurethane is preferred. That is, it is preferable to form the cover of a resin blend in which the chief components are (I) a thermoplastic polyurethane and (II) a polyisocyanate compound.

It is recommended that components (I) and (II) have a combined weight which accounts for preferably at least 60%, and more preferably at least 70%, of the overall amount of the cover-forming resin composition. Components (I) and (II) are described in detail below.

The thermoplastic polyurethane (I) has a structure which includes soft segments composed of a polymeric polyol (polymeric glycol) that is a long-chain polyol, and hard segments composed of a chain extender and a polyisocyanate compound. Here, the long-chain polyol serving as a starting material may be any that has hitherto been used in the art relating to thermoplastic polyurethanes, and is not particularly limited. Illustrative examples include polyester polyols, polyether polyols, polycarbonate polyols, polyester polycarbonate polyols, polyolefin polyols, conjugated diene polymer-based polyols, castor oil-based polyols, silicone-based polyols and vinyl polymer-based polyols. These long-chain polyols may be used singly, or two or more may be used in combination. Of these, in terms of being able to synthesize a thermoplastic polyurethane having a high rebound resilience and excellent low-temperature properties, a polyether polyol is preferred.

Any chain extender that has hitherto been employed in the art relating to thermoplastic polyurethanes may be suitably used as the chain extender. For example, low-molecular-weight compounds with a molecular weight of 400 or less which have on the molecule two or more active hydrogen atoms capable of reacting with isocyanate groups are preferred. Illustrative, non-limiting, examples of the chain extender include 1,4-butylene glycol, 1,2-ethylene glycol, 1,3-butanediol, 1,6-hexanediol and 2,2-dimethyl-1,3-propanediol. Of these, the chain extender is preferably an aliphatic diol having from 2 to 12 carbon atoms, and is more preferably 1,4-butylene glycol.

Any polyisocyanate compound hitherto employed in the art relating to thermoplastic polyurethanes may be suitably used without particular limitation as the polyisocyanate compound. For example, use may be made of one or more selected from the group consisting of 4,4′-diphenylmethane diisocyanate, 2,4-toluene diisocyanate, 2,6-toluene diisocyanate, p-phenylene diisocyanate, xylylene diisocyanate, 1,5-naphthylene diisocyanate, tetramethylxylene diisocyanate, hydrogenated xylylene diisocyanate, dicyclohexylmethane diisocyanate, tetramethylene diisocyanate, hexamethylene diisocyanate, isophorone diisocyanate, norbornene diisocyanate, trimethylhexamethylene diisocyanate and dimer acid diisocyanate. However, depending on the type of isocyanate, the crosslinking reactions during injection molding may be difficult to control. In the practice of the invention, to provide a balance between stability at the time of production and the properties that are manifested, it is most preferable to use the following aromatic diisocyanate: 4,4′-diphenylmethane diisocyanate.

Commercially available products may be used as the thermoplastic polyurethane serving as component (I). Illustrative examples include Pandex T-8295, Pandex T-8290 and Pandex T-8260 (all from DIC Covestro Polymer, Ltd.).

A thermoplastic elastomer other than the above thermoplastic polyurethanes may also be optionally included as a separate component, i.e., component (III), together with above components (I) and (II). By including this component (III) in the above resin blend, the flowability of the resin blend can be further improved and the properties required of a golf ball cover material, such as resilience and scuff resistance, can be increased. The compositional ratio of components (I), (II) and (III) is not particularly limited.

However, to fully elicit the advantageous effects of the invention, the compositional ratio (I):(II):(III) is preferably in the weight ratio range of from 100:2:50 to 100:50:0, and is more preferably from 100:2:50 to 100:30:8.

In addition, various additives other than the ingredients making up the above thermoplastic polyurethane may be optionally included in this resin blend. For example, pigments, dispersants, antioxidants, light stabilizers, ultraviolet absorbers and internal mold lubricants may be suitably included.

The manufacture of golf balls in which the above-described core, intermediate layer and cover (outermost layer) are formed as successive layers may be carried out in the usual manner, such as by a known injection molding process. For example, a golf ball can be produced by injection-molding the intermediate layer material over the core in an injection mold so as to obtain an intermediate layer-encased sphere, and then injection-molding the material for the cover serving as the outermost layer over the intermediate layer-encased sphere. Alternatively, the respective encasing layers may each be formed by enclosing the sphere to be encased within two pre-molded hemispherical half-cups and then molding under applied heat and pressure.

Hardness Relationships Among Layers

In the golf ball of the invention, the surface hardness of the intermediate layer-encased sphere is set higher than the surface hardness of the ball. That is, the value obtained by subtracting the Shore C hardness at the surface of the ball from the Shore C hardness at the surface of the intermediate layer-encased sphere is more than 0, preferably at least 5, and more preferably at least 9. The upper limit value is preferably not more than 20, more preferably not more than 17, and even more preferably not more than 15. In cases where this value is small, when the small value is attributable to the material hardness of the intermediate layer, the spin rate may rise on full shots and the intended distance may not be achieved. When the small value is attributable the material hardness of the cover, the spin controllability in the short game may worsen or the scuff resistance may worsen. On the other hand, in cases where this value is large, when the large value is attributable to the material hardness of the intermediate layer, the durability to cracking on repeated impact may worsen or the feel at impact may become too hard. When the large value is attributable to the material hardness of the cover, the spin rate on full shots may rise and the intended distance may not be achieved.

It is preferable for the surface hardness of the intermediate layer-encased sphere to be higher than the surface hardness of the core. The Shore C hardness value obtained by subtracting the surface hardness of the core from the surface hardness of the intermediate layer-encased sphere is preferably at least 1, more preferably at least 5, and even more preferably at least 10; the upper limit value is preferably not more than 30, more preferably not more than 24, and even more preferably not more than 18. When this value is too small, the spin rate on full shots may rise and a good distance may not be achieved. On the other hand, when this value is too large, the durability to cracking on repeated impact may worsen.

Also, in the golf ball of the invention, it is preferable for the following condition to be satisfied:

(Shore C hardness at surface of intermediate layer-encased sphere)/{(Shore C hardness at core surface−Shore C hardness at core center)×intermediate layer thickness (mm)}2.7.

This expression means that the hardness difference between the core surface and

center is relatively large and that the intermediate layer, although relatively hard, has a layer thickness that is not too thin.

The value of (Shore C hardness at surface of intermediate layer-encased sphere)/{(Shore C hardness at core surface−Shore C hardness at core center)×intermediate layer thickness (mm)} is 2.7 or less, preferably 2.6 or less, and more preferably 2.5 or less. The lower limit value is preferably at least 1.5, more preferably at least 1.8, and even more preferably at least 2.0. When this value is too large, the spin rate on full shots may increase and the intended distance may not be achievable. On the other hand, when this value is too small, the durability to repeated impact may worsen or the feel at impact may worsen.

Specific Gravities of the Layers

In this invention, it is recommended that the differences among the specific gravities of the core, the intermediate layer and the cover be generally within ±0.25, preferably within ±0.10, and more preferably within ±0.05. That is, the value of (specific gravity of core)−(specific gravity of intermediate layer material), the value of the (specific gravity of cover material)−(specific gravity of intermediate layer material) and the value of (specific gravity of core)−(specific gravity of cover material) are each generally equal to or more than −0.25, preferably equal to or more than −0.10, and more preferably equal to or more than −0.05; the upper limit value of each of these differences is generally 0.25 or less, preferably 0.10 or less, and more preferably 0.05 or less. If the weight differences between these layers are too large, in cases where the intermediate layer material and/or the cover material cannot be molded completely concentric with the layer positioned to the inside of these respective layers and they end up becoming eccentric, wobbling of the ball when hit with a putter may increase.

Compression Relationship between Core and Ball

The ball has an Atti compression which, although not particularly limited, is preferably at least 48, more preferably at least 53, and even more preferably at least 58. The upper limit is preferably not more than 80, more preferably not more than 75, and even more preferably not more than 70. When this compression value is too large, particularly on full shots with an iron, the spin rate may become too high and a good distance may not be achieved, or the feel may become too hard. On the other hand, when the compression value is too small, the feel may become too soft or the durability to cracking on repeated impact may worsen. As with Atti compression measurement of the core described above, the Atti compression of the ball is measured using the Atti compression tester from Atti Engineering Corporation.

The ratio C2/C1 between the Atti compressions of the ball and the core, where C1 is the Atti compression of the core and C2 is the Atti compression of the ball, is preferably at least 1.7, more preferably at least 2.0, and even more preferably at least 2.3. The upper limit is preferably not more than 4.0, more preferably not more than 3.7, and even more preferably not more than 3.5. When this value is too large, the durability to cracking on repeated impact may worsen. On the other hand, when this value is too small, the spin rate on full shots may rise and the intended distance may not be achieved.

The difference C2−C1 between the Atti compressions of the ball and the core is preferably at least 28, more preferably at least 33, and even more preferably at least 38. The upper limit is preferably not more than 50, more preferably not more than 47, and even more preferably not more than 45. When this value is too small, the spin rate on full shots may rise and the intended distance may not be achieved. On the other hand, when this value is too large, the durability to cracking on repeated impact may worsen.

Numerous dimples may be formed on the outside surface of the cover. The number of dimples arranged on the cover surface, although not particularly limited, is preferably at least 323, more preferably at least 326, and even more preferably at least 330. The number of dimples is preferably not more than 380, more preferably not more than 360, and even more preferably not more than 350. When the number of dimples is higher than this range, the ball trajectory may become lower and the distance traveled by the ball may decrease. On the other hand, when the number of dimples is lower that this range, the ball trajectory may become higher and a good distance may not be achieved.

The dimple shapes used may be of one type or may be a combination of two or more types suitably selected from among, for example, circular shapes, various polygonal shapes, dewdrop shapes and oval shapes. When circular dimples are used, the dimple diameter may be set to at least about 2.5 mm and up to about 6.5 mm, and the dimple depth may be set to at least 0.08 mm and up to 0.30 mm.

In order for the aerodynamic properties to be fully manifested, it is desirable for the dimple coverage ratio on the spherical surface of the golf ball, i.e., the dimple surface coverage SR, which is the sum of the individual dimple surface areas, each defined by the flat plane circumscribed by the edge of the dimple, as a percentage of the spherical surface area of the ball were the ball to have no dimples thereon, to be set to at least 70% and not more than 90%. Also, to optimize the ball trajectory, it is desirable for the value Vo, defined as the spatial volume of the individual dimples below the flat plane circumscribed by the dimple edge, divided by the volume of the cylinder whose base is the flat plane and whose height is the maximum depth of the dimple from the base, to be set to at least 0.35 and not more than 0.80. Moreover, it is preferable for the ratio VR of the sum of the volumes of the individual dimples, each formed below the flat plane circumscribed by the edge of the dimple, with respect to the volume of the ball sphere were the ball surface to have no dimples thereon, to be set to at least 0.6% and not more than 1.0%. Outside of the above ranges in these respective values, the resulting trajectory may not enable a good distance to be achieved and so the ball may fail to travel a fully satisfactory distance.

In the golf ball of the invention, it is desirable to optimize the ratios CL2/CL1 and CL4/CL3, where CL1 is the coefficient of lift at a Reynolds number of 80,000 and a spin rate of 2,000 rpm, CL2 is the coefficient of lift at a Reynolds number of 70,000 and a spin rate of 1,900 rpm, CL3 is the coefficient of lift at a Reynolds number of 200,000 and a spin rate of 2,500 rpm and CL4 is the coefficient of lift at a Reynolds number of 120,000 and a spin rate of 2,250 rpm.

In this Specification, the coefficients of lift (CL1, CL2, CL3 and CL4) are measured in conformity with the Indoor Test Range (ITR) method established by the United States Golf Association (USGA). The coefficient of lift can be adjusted by adjusting the dimple composition (arrangement, diameter, depth, volume, number, shape, etc.) on the golf ball. The coefficient of lift does not depend on the internal construction of the golf ball. The Reynolds number (Re) is a dimensionless number used in the field of fluid dynamics, and is calculated using formula (I) below.

Re=ρvL/μ (I)

In formula (I), ρ represents the density of a fluid, v is the average velocity of an object relative to flow by the fluid, L is a characteristic length, and μ is the coefficient of viscosity of the fluid.

The conditions under which the coefficient of lift CL1 is measured, i.e., a Reynolds number of 80,000 and a spin rate of 2,000 rpm, generally correspond approximately to the state at the time that the coefficient of lift begins to decrease and, in turn, the golf ball begins to fall after having reached its highest point following launch. The conditions under which the coefficient of lift CL2 is measured, i.e., a Reynolds number of 70,000 and a spin rate of 1,900 rpm, generally correspond approximately to the state just before the golf ball falls to the ground after having reached its highest point following launch. The above are particularly true in cases where the golf ball is launched under high-velocity conditions (e.g., an initial velocity of 66 m/s, a spin rate of 2,600 rpm, and a launch angle of 11°). These high-velocity conditions generally correspond to the launch conditions when the ball is hit with a driver by an amateur golfer.

The ratio CL2/CL1 has a value of preferably at least 0.950, more preferably at least and even more preferably at least 0.970. By satisfying this range, the decrease in lift as the golf ball falls can be suppressed, which in turn makes it easier for the flight distance (i.e., the carry) to be extended as the ball falls and for the run to be extended. Hence, the total distance can be increased. When CL2/CL1 is too low, the golf ball tends to fall more steeply, making it difficult to satisfactorily increase the carry and run. A higher CL2/CL1 is better from the standpoint of increasing the total distance. However, when this value is too high, the carry increases but the run decreases, as a result of which the total distance may not exceed the optimal value. Therefore, the upper limit value for CL2/CL1 is not more than 1.100, preferably not more than 1.050, more preferably not more than 1.044, and even more preferably not more than 1.022.

The conditions under which the coefficient of lift CL3 is measured, i.e. a Reynolds number of 200,000 and a spin rate of 2,500 rpm, generally correspond approximately to the state just after the golf ball has been launched under high-velocity conditions (e.g., an initial velocity of 72 m/s, a spin rate of 2,500 rpm and a launch angle of 10°). The conditions under which the coefficient of lift CL4 is measured, i.e. a Reynolds number of 120,000 and a spin rate of 2,250 rpm, generally correspond approximately to the state of the ball as it rises approximately 2 seconds after being launched under high-velocity conditions (e.g., an initial velocity of 72 m/s, a spin rate of 2,500 rpm and a launch angle of 10°).

The ratio CL4/CL3 has a value of preferably at least 1.250, more preferably at least 1.252, and even more preferably at least 1.255. The upper limit is preferably not more than 1.300, more preferably not more than 1.295, and even more preferably not more than 1.290. By setting the ratio in this range, when the golf ball has been launched under high-velocity conditions (e.g., when hit with a driver), the amount of rise by the golf ball can be kept from becoming excessive (i.e., the ball can be kept from climbing too steeply), making it possible to increase the resistance of the ball to the wind and thus enabling the carry to be increased. In addition, the run can be increased. This enables the total distance traveled by the ball to be increased.

From the standpoint of increasing the distance traveled by the ball, the coefficient of lift CL1 is preferably at least 0.230, the coefficient of lift CL2 is preferably at least 0.230, the coefficient of lift CL3 is preferably at least 0.145 and the coefficient of lift CL4 is preferably at least 0.185. Also, CL1 is preferably not more than 0.240, CL2 is preferably not more than 0.240, CL3 is preferably not more than 0.155 and CL4 is preferably not more than 0.195.

A coating layer is formed on the surface of the cover. This coating layer can be formed by applying various types of coating materials. Because the coating layer must be capable of enduring the harsh conditions of golf ball use, it is desirable to use a coating composition in which the chief component is a urethane coating material composed of a polyol and a polyisocyanate.

The polyol component is exemplified by acrylic polyols and polyester polyols. These polyols include modified polyols. To further increase workability, other polyols may also be added.

The acrylic polyol is exemplified by homopolymers and copolymers of monomers having functional groups that react with isocyanate. Such monomers are exemplified by alkyl esters of (meth)acrylic acid, illustrative examples of which include methyl (meth)acrylate, ethyl (meth)acrylate, isopropyl (meth)acrylate, butyl (meth)acrylate, isobutyl (meth)acrylate, 2-ethylhexyl (meth)acrylate, lauryl (meth)acrylate, stearyl (meth)acrylate, cyclohexyl (meth)acrylate, isobornyl (meth)acrylate, 2-hydroxyethyl (meth)acrylate, 2-hydroxypropyl (meth)acrylate and 4-hydroxybutyl (meth)acrylate. These may be used singly or two or more may be used together.

Modified acrylic polyols that may be used include polyester-modified acrylic polyols. Examples of other polyols include polyether polyols such as polyoxyethylene glycol (PEG), polyoxypropylene glycol (PPG) and polyoxytetramethylene glycol (PTMG); condensed polyester polyols such as polyethylene adipate (PEA), polybutylene adipate (PBA) and polyhexamethylene adipate (PH2A); lactone-type polyester polyols such as poly-ε-caprolactone (PCL); and polycarbonate polyols such as polyhexamethylene carbonate. These may be used singly or two or more may be used together. The ratio of these polyols to the total amount of acrylic polyol is preferably not more than 50 wt %, and more preferably not more than 40 wt %.

Polyester polyols are obtained by the polycondensation of a polyol with a polybasic acid. Examples of the polyol include diols such as ethylene glycol, 1,2-propanediol, 1,3-propanediol, 1,3-butanediol, 1,4-butanediol, 1,6-hexanediol, neopentyl glycol, diethylene glycol, dipropylene glycol, hexylene glycol, dimethylol heptane, polyethylene glycol and polypropylene glycol; and also triols, tetraols, and polyols having an alicyclic structure. Examples of the polybasic acid include aliphatic dicarboxylic acids such as succinic acid, adipic acid, sebacic acid, azelaic acid and dimer acid; aliphatic unsaturated dicarboxylic acids such as fumaric acid, maleic acid, itaconic acid and citraconic acid; aromatic polycarboxylic acids such as phthalic acid, isophthalic acid, terephthalic acid, trimellitic acid and pyromellitic acid; dicarboxylic acids having an alicyclic structure, such as tetrahydrophthalic acid, hexahydrophthalic acid, 1,3-cyclohexanedicarboxylic acid, 1,4-cyclohexanedicarboxylic acid and endomethylene tetrahydrophthalic acid; and tris-2-carboxyethyl isocyanurate.

It is suitable to use two types of polyester polyol together as the polyol component. Letting the two types of polyester polyol be component A and component B, a polyester polyol in which a cyclic structure has been introduced onto the resin skeleton may be used as the polyester polyol of component A. Examples include polyester polyols obtained by the polycondensation of a polyol having an alicyclic structure, such as cyclohexane dimethanol, with a polybasic acid; and polyester polyols obtained by the polycondensation of a polyol having an alicyclic structure with a diol or triol and a polybasic acid. A polyester polyol having a multibranched structure may be used as the polyester polyol of component B. Examples include polyester polyols having a branched structure, such as NIPPOLAN 800 from Tosoh Corporation.

The weight-average molecular weight (Mw) of the overall base resin containing the above two types of polyester polyol is preferably from 13,000 to 23,000, and more preferably from 15,000 to 22,000. The number-average molecular weight (Mn) of the overall base resin containing these two types of polyester polyol is preferably from 1,100 to 2,000, and more preferably from 1,300 to 1,850. Outside of these ranges in the average molecular weights (Mw and Mn), the wear resistance of the coating layer may decrease. The weight-average molecular weight (Mw) and the number-average molecular weight (Mn) are polystyrene-equivalent measured values obtained by gel permeation chromatography (GPC) using differential refractometry.

The contents of these two types of polyester polyol (components A and B) are not particularly limited, although the content of component A is preferably from 20 to 30 wt % of the total amount of the base resin and the content of component B is preferably from 2 to 18 wt % of the total amount of the base resin.

The polyisocyanate is exemplified, without particular limitation, by commonly used aromatic, aliphatic, alicyclic and other polyisocyanates. Specific examples include tolylene diisocyanate, diphenylmethane diisocyanate, xylylene diisocyanate, tetramethylene diisocyanate, hexamethylene diisocyanate, lysine diisocyanate, isophorone diisocyanate, 1,4-cyclohexylene diisocyanate, naphthalene diisocyanate, trimethylhexamethylene diisocyanate, dicyclohexylmethane diisocyanate and 1-isocyanato-3,3,5-trimethyl-4-isocyanatomethylcyclohexane. These may be used singly or in admixture.

Modified forms of hexamethylene diisocyanate include, for example, polyester-modified hexamethylene diisocyanate and urethane-modified hexamethylene diisocyanate. Derivatives of hexamethylene diisocyanate include isocyanurates, biurets and adducts of hexamethylene diisocyanate.

The molar ratio of isocyanate (NCO) groups on the polyisocyanate to hydroxyl (OH) groups on the polyol, expressed as NCO/OH, is preferably in the range of 0.5 to 1.5, more preferably from 0.8 to 1.2, and even more preferably from 1.0 to 1.2. At less than 0.5, unreacted hydroxyl groups remain, which may adversely affect the performance and water resistance of the coating layer. On the other hand, at above 1.5, the number of isocyanate groups becomes excessive and urea groups (which are fragile) form in reactions with moisture, as a result of which the performance of the coating layer may decline.

An amine catalyst or an organometallic catalyst may be used as the curing catalyst (organometallic compound). Examples of the organometallic compound include soaps of metals such as aluminum, nickel, zinc or tin. Preferred use can be made of such compounds which have hitherto been included as curing agents for two-part curing urethane coatings.

Depending on the coating conditions, various types of organic solvents may be mixed into the coating composition. Examples of such organic solvents include aromatic solvents such as toluene, xylene and ethylbenzene; ester solvents such as ethyl acetate, butyl acetate, propylene glycol methyl ether acetate and propylene glycol methyl ether propionate; ketone solvents such as acetone, methyl ethyl ketone, methyl isobutyl ketone and cyclohexanone; ether solvents such as diethylene glycol dimethyl ether, diethylene glycol diethyl ether and dipropylene glycol dimethyl ether; alicyclic hydrocarbon solvents such as cyclohexane, methyl cyclohexane and ethyl cyclohexane; and petroleum hydrocarbon solvents such as mineral spirits.

Known coating ingredients may be optionally added to the coating composition. For example, thickeners, ultraviolet absorbers, fluorescent brighteners, slip agents and pigments may be included in suitable amounts.

The thickness of the coating layer made of the coating composition, although not particularly limited, is typically from 5 to 40 μm, and preferably from 10 to 20 μm. As used herein, “coating layer thickness” refers not to the coating layer formed within the dimples, but to the thickness of the coating formed on the ball surface outside of the dimples (also referred to as the “lands”).

In this invention, the coating layer made of the above coating composition has an elastic work recovery that is preferably at least 60%, more preferably at least 70%, and even more preferably at least 80%. At a coating layer elastic work recovery in this range, the coating layer has a high elasticity and so the self-repairing ability is high, resulting in an outstanding abrasion resistance. Moreover, the performance attributes of golf balls coated with this coating composition can be improved. The method of measuring the elastic work recovery is described below.

The elastic work recovery is one parameter of the nanoindentation method for evaluating the physical properties of coating layers, this being a nanohardness test method that controls the indentation load on a micro-newton (μN) order and tracks the indenter depth during indentation to a nanometer (nm) precision. In prior methods, only the size of the deformation (plastic deformation) mark corresponding to the maximum load could be measured. However, in the nanoindentation method, the relationship between the indentation load and the indentation depth can be obtained by continuous automated measurement. Hence, unlike in the past, there are no individual differences between observers when visually measuring a deformation mark under an optical microscope, and so it is thought that the physical properties of the coating layer can be precisely evaluated. Given that the coating layer on the ball surface is strongly affected by the impact of the driver and various other types of clubs and has a not inconsiderable influence on the golf ball properties, measuring the coating layer by the nanohardness test method and carrying out such measurement to a higher precision than in the past is a very effective method of evaluation.

The hardness of the coating layer, as expressed on the Shore M hardness scale, is preferably at least 40, and more preferably at least 60. The upper limit is preferably not more than 95, and more preferably not more than 85. This Shore M hardness is obtained in accordance with ASTM D2240. The hardness of the coating layer, as expressed on the Shore C hardness scale, is preferably at least 40 and has an upper limit of preferably not more than 80. This Shore C hardness is obtained in accordance with ASTM D2240. At coating layer hardnesses that are higher than these ranges, the coating may become brittle when the ball is repeatedly struck, which may make it incapable of protecting the cover layer. On the other hand, coating layer hardnesses that are lower than the above range are undesirable because the ball surface may be more easily damaged when striking a hard object and mud may stick more readily to the ball.

When the above coating composition is used, the formation of a coating layer on the surface of golf balls manufactured by a known method can be carried out via the steps of preparing the coating composition at the time of application, applying the composition onto the golf ball surface by a conventional coating operation, and drying the applied composition. The coating method is not particularly limited. For example, spray painting, electrostatic painting or dipping may be suitably used.

### EXAMPLES

The following Examples and Comparative Examples are provided to illustrate the invention, and are not intended to limit the scope thereof.

### Examples 1 to 6, Comparative Examples 1 to 7

Formation of Core

Solid cores were produced by preparing the rubber compositions for Examples 3 to 6 and Comparative Examples 1 to 3 shown in Table 1 and then molding and vulcanizing the compositions under the temperature and time conditions shown in Table 1.

In Examples 1 and 2 and Comparative Examples 4 to 7, solid cores are produced in the same way as above using the rubber compositions and vulcanization conditions shown in Table 1.

TABLE 1

| | | Example | | | | | | Comparative Example | | | | | | |
|---|---|---|---|---|---|---|---|---|---|---|---|---|---|---|
| Formulation (pbw) | | 1 | 2 | 3 | 4 | 5 | 6 | 1 | 2 | 3 | 4 | 5 | 6 | 7 |
| (A) | Polybutadiene A | | | | | | | 100 | | | | | | |
| | Polybutadiene B | 100 | 100 | 100 | 100 | 100 | 100 | | 100 | 100 | 100 | 100 | 100 | |
| | Polybutadiene C | | | | | | | | | | | | | 100 |
| — | Zinc acrylate | 27.0 | 27.0 | 33.0 | 33.0 | 27.0 | 27.0 | 35.3 | 35.5 | 34.0 | 29.5 | 27.0 | 34.0 | 30.5 |
| (B) | Organic peroxide | 1.0 | 1.0 | 1.0 | 1.0 | 1.0 | 1.0 | 1.0 | 1.0 | 1.0 | 1.0 | 1.0 | 1.0 | 0.6 |
| — | Zinc stearate | 2.0 | 2.0 | 2.0 | 2.0 | 2.0 | 2.0 | | | | | 2.0 | | |
| (D) | Sulfur | 0.01 | 0.01 | 0.04 | 0.04 | 0.01 | 0.01 | | 0.04 | 0.01 | | 0.01 | 0.01 | |
| (C) | Water | 0.6 | 0.6 | 0.6 | 0.6 | 0.6 | 0.6 | 0.4 | 0.2 | 0.2 | 0.4 | 0.6 | 0.2 | 0.8 |
| — | Antioxidant A | | | | | | | 0.1 | | | 0.1 | | | 0.1 |
| — | Antioxidant B | 0.3 | 0.3 | 0.3 | 0.3 | 0.3 | 0.3 | | 0.3 | 0.3 | | 0.3 | 0.3 | |
| — | Zinc oxide | 15.0 | 15.3 | 20.2 | 20.2 | 22.6 | 22.6 | 16.2 | 17.1 | 17.8 | 18.8 | 20.6 | 20.8 | 13.4 |
| — | Zinc salt of | 0.3 | 0.3 | 0.3 | 0.3 | 0.3 | 0.3 | 0.6 | 0.3 | 0.3 | 0.2 | 0.3 | 0.3 | 1.0 |
| | pentachloro- | | | | | | | | | | | | | |
| | thiophenol | | | | | | | | | | | | | |
| (D) Sulfur component/(C) | | 0.02 | 0.02 | 0.051 | 0.051 | 0.017 | 0.017 | 0.000 | 0.152 | 0.052 | 0.000 | 0.017 | 0.052 | 0.000 |
| (weight ratio) | | | | | | | | | | | | | | |
| Vulcanization | Temperature | 148 | 148 | 148 | 158 | 148 | 158 | 148 | 148 | 148 | 148 | 158 | 148 | 152 |
| conditions | (° C.) | | | | | | | | | | | | | |
| | Time (min) | 19 | 19 | 19 | 14 | 19 | 14 | 19 | 19 | 19 | 19 | 14 | 19 | 19 |

Details on the ingredients mentioned in Table 1 are given below.
Polybutadiene A: Available under the trade name “BR01” from JSR Corporation
Polybutadiene B: Available under the trade name “T0700” from JSR Corporation
Polybutadiene C: Available under the trade name “BR730” from JSR Corporation
Zinc acrylate: “ZN-DA85S” from Nippon Shokubai Co., Ltd.
Organic Peroxide: Dicumyl peroxide, available under the trade name “Percumyl D” from NOF Corporation; one-minute half-life temperature, 175.2° C.
Zinc stearate: Available under the trade name “Zinc Stearate G” from NOF Corporation
Sulfur: Sulfur masterbatch containing 80 wt % of powder sulfur for rubber, available under the trade name Sanmix S-80N from Sanshin Chemical Industry Col., Ltd.
Water: Pure water (from Seiki Chemical Industrial Co., Ltd.)
Antioxidant A: 2,2′-Methylenebis(4-methyl-6-butylphenol), available under the trade name “Nocrac NS-6” from Ouchi Shinko Chemical Industry Co., Ltd.
Antioxidant B:2-Mercaptobenzimidazole, available under the trade name “Nocrac MB” from Ouchi Shinko Chemical Industry Co., Ltd.
Zinc oxide: Available as “Grade 3 Zinc Oxide” from Sakai Chemical Co., Ltd.
Zinc salt of pentachlorothiophenol:
   Available from Wako Pure Chemical Industries, Ltd.

Formation of Intermediate Layer and Cover (Outermost Layer) Next, in Examples 3 to 6 and Comparative Examples 1 to 3, an intermediate layer

was formed by injection-molding the intermediate layer material formulated as shown in Table 2 over the core obtained above, thereby producing an intermediate layer-encased sphere. A cover (outermost layer) was then formed by injection-molding the cover material formulated as shown in the same table over the resulting intermediate layer-encased sphere, thereby producing the golf ball. The Type A dimples or Type B dimples shown below were formed at this time on the cover surface.

In Examples 1 and 2 and Comparative Examples 4 to 7, golf balls are produced in the same way as above by injection-molding the intermediate layer material and the cover material formulated as shown in Table 2. The Type A dimples or Type B dimples shown below are formed on the cover surface in Examples 1 and 2 and Comparative Examples 4 to 7.

TABLE 2

| Resin | No. | No. | No. | No. | No. | No. | No. |
|---|---|---|---|---|---|---|---|
| composition (pbw) | 1 | 2 | 3 | 4 | 5 | 6 | 7 |
| Himilan ® 1605 | 50 | | 50 | | | | |
| Himilan ® 1557 | 15 | 15 | 15 | | 15 | | |
| Himilan ® 1706 | 35 | | 35 | 15 | | | |
| AM 7318 | | 85 | | 85 | 85 | | |
| Barium sulfate | 20 | 20 | | | | | |
| Trimethylolpropane | 1.1 | 1.1 | 1.1 | 1.1 | 1.1 | | |
| TPU 1 | | | | | | 100 | |
| TPU 2 | | | | | | | 100 |

Trade names for the materials in the above table are given below.
Himilan® 1605, Himilan® 1557, Himilan® 1706:
Ionomers available from Dow-Mitsui Polychemicals Co., Ltd.
AM7318: An ionomer available from Dow-Mitsui Polychemicals Co., Ltd.
Barium sulfate: Available from Sakai Chemical Industry Co., Ltd. as “Precipitated
Barium Sulfate 300”
Trimethylolpropane (TMP):
Available from Tokyo Chemical Industry Co., Ltd.
TPU 1: An ether-type thermoplastic polyurethane available as Pandex® from DIC Covestro
Polymer, Ltd.; material hardness (Shore D), 50
TPU 2: An ether-type thermoplastic polyurethane available as Pandex® from DIC Covestro
Polymer, Ltd.; material hardness (Shore D), 43

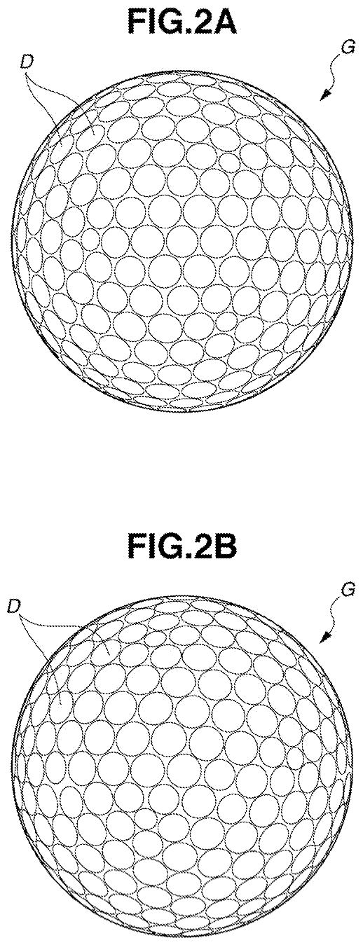

Six varieties of circular dimples are used as the Type A dimples. The details are shown in Table 3 below. The dimples are arranged as shown in FIG. 2. FIG. 2A is a top view of the dimples and FIG. 2B is a side view of the dimples.

TABLE 3

| Type A | | Diameter | Depth | Volume | Cylinder | SR | VR |
|---|---|---|---|---|---|---|---|
| dimples | Number | (mm) | (mm) | (mm³) | volume ratio | (%) | (%) |
| A-1 | 204 | 4.4 | 0.136 | 1.013 | 0.490 | 82.8 | 0.77 |
| A-2 | 48 | 3.9 | 0.135 | 0.790 | 0.490 | | |
| A-3 | 12 | 2.9 | 0.100 | 0.324 | 0.490 | | |
| A-4 | 36 | 4.3 | 0.144 | 1.024 | 0.490 | | |
| A-5 | 24 | 3.9 | 0.143 | 0.837 | 0.490 | | |
| A-6 | 14 | 4.0 | 0.120 | 0.739 | 0.490 | | |
| Total | 338 | | | | | | |

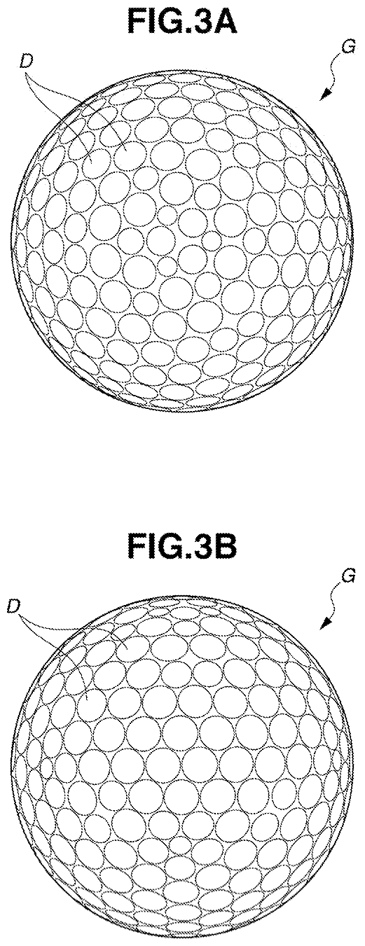

Eight varieties of circular dimples are used as the Type B dimples. The details are shown in Table 4 below. The dimples are arranged as shown in FIG. 3. FIG. 3A is a top view of the dimples and FIG. 3B is a side view of the dimples.

TABLE 4

| Type B | | Diameter | Depth | Volume | Cylinder | SR | VR |
|---|---|---|---|---|---|---|---|
| dimples | Number | (mm) | (mm) | (mm³) | volume ratio | (%) | (%) |
| B-1 | 12 | 4.6 | 0.123 | 1.116 | 0.546 | 82.3 | 0.78 |
| B-2 | 198 | 4.45 | 0.122 | 1.036 | 0.546 | | |
| B-3 | 36 | 3.85 | 0.119 | 0.757 | 0.546 | | |
| B-4 | 12 | 2.75 | 0.090 | 0.288 | 0.539 | | |
| B-5 | 36 | 4.45 | 0.136 | 1.120 | 0.530 | | |
| B-6 | 24 | 3.85 | 0.133 | 0.820 | 0.530 | | |
| B-7 | 6 | 3.4 | 0.118 | 0.563 | 0.526 | | |
| B-8 | 6 | 3.3 | 0.118 | 0.530 | 0.525 | | |
| Total | 330 | | | | | | |

Dimple Definitions
Edge: Highest place in cross-section passing through center of dimple.
Diameter: Diameter of flat plane circumscribed by edge of dimple.
Depth: Maximum depth of dimple from flat plane circumscribed by edge of dimple.
SR: Sum of individual dimple surface areas, each defined by flat plane circumscribed by edge of dimple, as a percentage of spherical surface area of ball were it to have no dimples thereon.
Dimple volume: Dimple volume below flat plane circumscribed by edge of dimple.
Cylinder volume ratio: Ratio of dimple volume to volume of cylinder having same diameter and depth as dimple.
VR: Sum of volumes of individual dimples formed below flat plane circumscribed by edge of dimple, as a percentage of volume of ball sphere were it to have no dimples thereon.

Table 5 below shows the coefficient of lift CL1 measured at a Reynolds number of and a spin rate of 2,000 rpm, the coefficient of lift CL2 measured at a Reynolds number of 70,000 and a spin rate of 1,900 rpm, the coefficient of lift CL3 measured at a Reynolds number of 200,000 and a spin rate of 2,500 rpm, the coefficient of lift CL4 measured at a Reynolds number of 120,000 and a spin rate of 2,250 rpm, and the values of the ratios CL2/CL1 and CL4/CL3 for golf balls having the above Type A or Type B dimples formed on the cover surface. These coefficients of lift are measured in conformity with the Indoor Test Range (ITR) method established by the USGA.

TABLE 5

| Dimples | CL1 | CL2 | CL3 | CL4 | CL2/CL1 | CL4/CL3 |
|---|---|---|---|---|---|---|
| Type A | 0.240 | 0.235 | 0.148 | 0.191 | 0.980 | 1.286 |
| dimples | | | | | | |
| Type B | 0.234 | 0.238 | 0.148 | 0.186 | 1.018 | 1.262 |
| dimples | | | | | | |

Various properties of the resulting golf balls, including the internal hardnesses of the core at various positions, the diameters of the core and each layer-encased sphere, the thickness and material hardness of each layer, and the surface hardness of each layer-encased sphere, are measured by the following methods. The results are presented in Table 6.

Diameters of Core and Intermediate Layer-Encased Sphere

The spheres to be measured are held isothermally for at least 3 hours in a thermostatic chamber adjusted to 23.9±1° C., following which they are measured in a 23.9±2° C. room. The diameters at five random places on the surface of each sphere are measured and, using the average of these measurements as the measured value for a single sphere, the average diameter for ten such spheres is determined.

Ball Diameter

The balls to be measured are held isothermally for at least 3 hours in a thermostatic chamber adjusted to 23.9±1° C., following which they are measured in a 23.9±2° C. room. The diameters at 15 random dimple-free areas are measured and, using the average of these measurements as the measured value for a single ball, the average diameter for ten balls is determined.

Atti Compressions of Core and Ball

The Atti compression of the core or ball is measured with the Atti compression tester from Atti Engineering Corporation. The tester is designed to measure a spherical specimen having a diameter of 42.7 mm (1.68 inches). When measuring the compression of a core, because the core has a smaller diameter than the ball, measurement is carried out after inserting a spacer shim between the plunger and the core so as to bring the (core diameter+shim thickness) up to 42.7 mm.

Core Hardness Profile

The indenter of a durometer is set substantially perpendicular to the spherical surface of the core, and the surface hardness on the Shore C hardness scale is measured in accordance with ASTM D2240. The hardnesses at the center and specific positions of the core are measured as Shore C hardness values by cutting the core into hemispheres so as to form a cross-section that is a flat plane, and perpendicularly pressing the indenter of a durometer against the flat cross-section at the center and other specific positions shown in Table 6. The P2 Automatic Rubber Hardness Tester (Kobunshi Keiki Co., Ltd.) equipped with a Shore C durometer can be used for measuring the hardness. The maximum value is read off as the hardness value. Measurements are all carried out in a 23±2° C. environment. The numbers in Table 6 are Shore C hardness values.

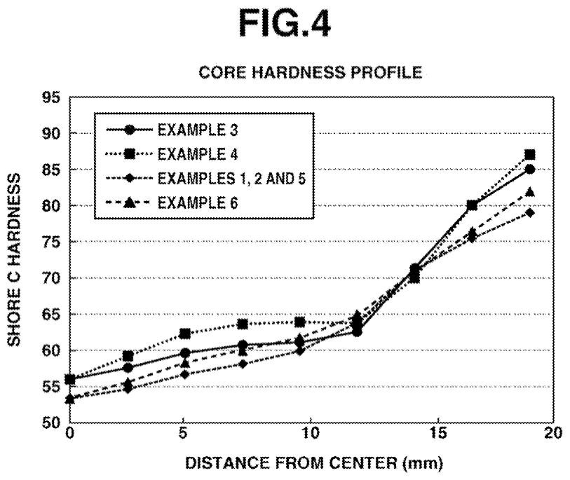

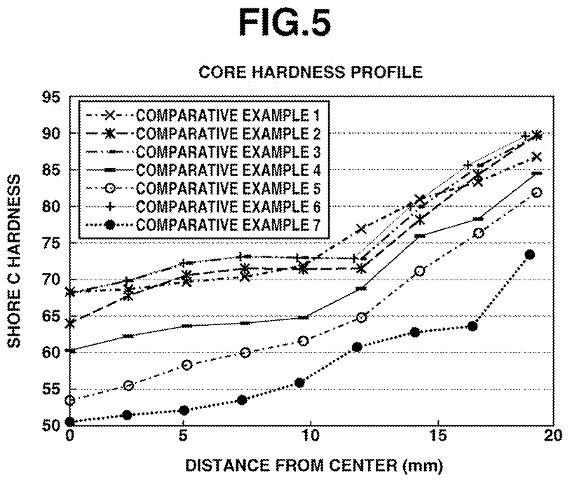

FIGS. 4 and 5 show graphs of the core hardness profiles for Examples 1 to 6 and Comparative Examples 1 to 7.

Material Hardnesses of Intermediate Layer and Cover

The resin material for each layer is molded into a sheet having a thickness of 2 mm and left to stand for at least two weeks. The Shore C hardness and Shore D hardness of each material are then measured in accordance with ASTM D2240. The P2 Automatic Rubber Hardness Tester (Kobunshi Keiki Co., Ltd.) is used for measuring the hardnesses. Shore C hardness and Shore D hardness attachments are mounted on the tester and the respective hardnesses are measured. The maximum value is read off as the hardness value. All measurements are carried out in a 23±2° C. environment.

Surface Hardnesses of Intermediate Layer-Encased Sphere and Ball

These hardnesses are measured by perpendicularly pressing an indenter against the surfaces of the respective spheres. The surface hardness of a ball (cover) is the value measured at a dimple-free area (land) on the surface of the ball. The Shore C and Shore D hardnesses are measured in accordance with ASTM D2240. The P2 Automatic Rubber Hardness Tester (Kobunshi Keiki Co., Ltd.) is used for measuring the hardness. Shore C hardness and Shore D hardness attachments are mounted on the tester and the respective hardnesses are measured. The maximum value is read off as the hardness value. Measurements are all carried out in a 23±2° C. environment.

TABLE 6-I

| Example | | | | | | Comparative Example | | | | | | |
|---|---|---|---|---|---|---|---|---|---|---|---|---|
| 1 | 2 | 3 | 4 | 5 | 6 | 1 | 2 | 3 | 4 | 5 | 6 | 7 |

| Construction (piece) | | 3P | 3P | 3P | 3P | 3P | 3P | 3P | 3P | 3P | 3P | 3P | 3P | 3P |
|---|---|---|---|---|---|---|---|---|---|---|---|---|---|---|
| Core | | | | | | | | | | | | | | |
| Diameter (mm) | | 38.04 | 38.04 | 38.05 | 38.03 | 38.06 | 38.05 | 38.67 | 38.66 | 38.66 | 38.67 | 38.70 | 37.68 | 38.04 |
| Weight (g) | | 32.61 | 32.66 | 33.93 | 33.94 | 33.98 | 33.96 | 35.12 | 35.07 | 35.26 | 35.12 | 35.38 | 33.14 | 32.61 |
| Specific gravity | | 1.13 | 1.13 | 1.18 | 1.18 | 1.18 | 1.18 | 1.16 | 1.16 | 1.17 | 1.16 | 1.17 | 1.18 | 1.13 |
| Compression | | 17 | 17 | 30 | 30 | 17 | 20 | 71 | 69 | 74 | 57 | 20 | 74 | 13 |
| (Atti) | | | | | | | | | | | | | | |
| Core hardness | | | | | | | | | | | | | | |
| profile | | | | | | | | | | | | | | |
| H100 (Shore C) | | 79.0 | 79.0 | 84.9 | 87.0 | 79.0 | 81.9 | 86.7 | 89.6 | 89.5 | 84.5 | 81.9 | 89.5 | 73.4 |
| H87.5 (Shore C) | | 75.5 | 75.5 | 79.9 | 79.9 | 75.5 | 76.3 | 83.3 | 84.3 | 85.5 | 78.2 | 76.3 | 85.5 | 63.6 |
| H75 (Shore C) | | 71.1 | 71.1 | 71.3 | 69.9 | 71.1 | 71.1 | 80.9 | 78.2 | 79.9 | 75.9 | 71.1 | 79.9 | 62.8 |
| H62.5 (Shore C) | | 63.8 | 63.8 | 62.6 | 63.8 | 63.8 | 64.8 | 76.8 | 71.5 | 72.9 | 68.7 | 64.8 | 72.9 | 60.8 |
| H50 (Shore C) | | 59.9 | 59.9 | 61.2 | 63.9 | 59.9 | 61.6 | 71.8 | 71.4 | 72.9 | 64.7 | 61.6 | 72.9 | 55.9 |
| H37.5 (Shore C) | | 58.1 | 58.1 | 60.7 | 63.6 | 58.1 | 60.1 | 70.3 | 71.4 | 73.1 | 64.1 | 60.1 | 73.1 | 53.5 |
| H25 (Shore C) | | 56.7 | 56.7 | 59.7 | 62.3 | 56.7 | 58.3 | 69.6 | 70.6 | 72.2 | 63.6 | 58.3 | 72.2 | 52.1 |
| H12.5 (Shore C) | | 54.7 | 54.7 | 57.7 | 59.2 | 54.7 | 55.5 | 68.6 | 67.8 | 69.7 | 62.2 | 55.5 | 69.7 | 51.5 |
| H0 (Shore C) | | 53.3 | 53.3 | 56.0 | 56.1 | 53.3 | 53.5 | 68.3 | 64.0 | 68.0 | 60.3 | 53.5 | 68.0 | 50.6 |
| H100 − H87.5 | | 3.5 | 3.5 | 5.0 | 7.1 | 3.5 | 5.6 | 3.4 | 5.3 | 4.0 | 6.3 | 5.6 | 4.0 | 9.8 |
| (Shore C) | | | | | | | | | | | | | | |
| H87.5 − H75 | | 4.4 | 4.4 | 8.6 | 10.0 | 4.4 | 5.2 | 2.4 | 6.1 | 5.6 | 2.3 | 5.2 | 5.6 | 0.8 |
| (Shore C) | | | | | | | | | | | | | | |
| H100 − H0 | | 25.7 | 25.7 | 28.9 | 30.9 | 25.7 | 28.4 | 18.4 | 25.6 | 21.5 | 24.2 | 28.4 | 21.5 | 22.8 |
| (Shore C) | | | | | | | | | | | | | | |
| (H87.5 − H75) − | | 0.9 | 0.9 | 3.6 | 2.9 | 0.9 | −0.4 | −1.0 | 0.8 | 1.6 | −4.0 | −0.4 | 1.6 | −9.0 |
| (H100 − H87.5) | | | | | | | | | | | | | | |
| (Shore C) | | | | | | | | | | | | | | |
| (H100 − H0)/ | | 3.9 | 3.9 | 5.6 | 4.0 | 3.9 | 3.5 | 5.3 | 3.5 | 4.4 | 5.5 | 3.5 | 4.4 | 4.3 |
| (H50 − H0) | | | | | | | | | | | | | | |
| Core compression/ | | 0.7 | 0.7 | 1.0 | 1.0 | 0.7 | 0.7 | 3.9 | 2.7 | 3.4 | 2.4 | 0.7 | 3.4 | 0.6 |
| (H100 − H0) | | | | | | | | | | | | | | |
| Intermediate layer | | | | | | | | | | | | | | |
| Material | | No.1 | No.2 | No.3 | No.3 | No.3 | No.3 | No.4 | No.4 | No.4 | No.5 | No.3 | No.4 | No.1 |
| Thickness (mm) | | 1.49 | 1.51 | 1.52 | 1.53 | 1.52 | 1.53 | 1.20 | 1.22 | 1.21 | 1.21 | 1.20 | 1.70 | 1.49 |
| Specific gravity | | 1.09 | 1.09 | 0.93 | 0.93 | 0.93 | 0.93 | 0.95 | 0.95 | 0.95 | 0.95 | 0.93 | 0.95 | 1.09 |
| Volume (cm³) | | 7.32 | 7.40 | 7.45 | 7.50 | 7.48 | 7.51 | 5.99 | 6.07 | 6.04 | 6.05 | 6.00 | 8.29 | 7.32 |
| Material | Shore C | 95 | 95 | 93 | 93 | 93 | 93 | 95 | 95 | 95 | 94 | 93 | 95 | 95 |
| hardness | Shore D | 66 | 67 | 64 | 64 | 64 | 64 | 66 | 66 | 66 | 65 | 64 | 66 | 66 |
| Intermediate layer- | | | | | | | | | | | | | | |
| encased sphere | | | | | | | | | | | | | | |
| Diameter (mm) | | 41.02 | 41.05 | 41.08 | 41.08 | 41.10 | 41.10 | 41.07 | 41.09 | 41.08 | 41.09 | 41.10 | 41.08 | 41.02 |
| Weight (g) | | 40.62 | 40.71 | 40.88 | 40.92 | 40.96 | 40.97 | 40.80 | 40.84 | 41.02 | 40.86 | 40.97 | 41.02 | 40.62 |
| Surface | Shore C | 97 | 98 | 97 | 97 | 97 | 97 | 98 | 98 | 98 | 98 | 97 | 98 | 97 |
| hardness | Shore D | 71 | 71 | 70 | 70 | 70 | 70 | 71 | 71 | 71 | 71 | 70 | 71 | 71 |
| Intermediate layer | | 18 | 19 | 12 | 10 | 18 | 15 | 11 | 8 | 9 | 13 | 15 | 9 | 24 |
| surface hardness − | | | | | | | | | | | | | | |
| Core surface | | | | | | | | | | | | | | |
| hardness (Shore C) | | | | | | | | | | | | | | |
| (Shore C hardness | | 774 | 790 | 672 | 677 | 675 | 677 | 558 | 565 | 562 | 561 | 541 | 772 | 774 |
| at surface of | | | | | | | | | | | | | | |
| intermediate layer- | | | | | | | | | | | | | | |
| encased sphere) × | | | | | | | | | | | | | | |
| (Specific gravity of | | | | | | | | | | | | | | |
| intermediate layer | | | | | | | | | | | | | | |
| material) × | | | | | | | | | | | | | | |
| [Volume (cm³) | | | | | | | | | | | | | | |
| of intermediate | | | | | | | | | | | | | | |
| layer material] | | | | | | | | | | | | | | |
| Cover | | | | | | | | | | | | | | |
| Material | | No.7 | No.7 | No.6 | No.6 | No.7 | No.7 | No.6 | No.6 | No.6 | No.7 | No.7 | No.6 | No.7 |
| Thickness (mm) | | 0.85 | 0.83 | 0.82 | 0.82 | 0.81 | 0.81 | 0.81 | 0.81 | 0.81 | 0.81 | 0.81 | 0.81 | 0.85 |
| Specific gravity | | 1.10 | 1.10 | 1.10 | 1.10 | 1.10 | 1.10 | 1.08 | 1.08 | 1.08 | 1.10 | 1.10 | 1.08 | 1.10 |
| Material | Shore C | 67 | 67 | 76 | 76 | 67 | 67 | 76 | 76 | 76 | 67 | 67 | 76 | 67 |
| hardness | Shore D | 43 | 43 | 50 | 50 | 43 | 43 | 50 | 50 | 50 | 43 | 43 | 50 | 43 |
| Dimples | | | | | | | | | | | | | | |
| Configuration | | Type | Type | Type | Type | Type | Type | Type | Type | Type | Type | Type | Type | Type |
| | | A | A | A | A | A | A | B | B | B | B | A | B | A |
| Number | | 338 | 338 | 338 | 338 | 338 | 338 | 330 | 330 | 330 | 330 | 338 | 330 | 338 |
| Ball | | | | | | | | | | | | | | |
| Diameter (mm) | | 42.73 | 42.70 | 42.71 | 42.72 | 42.72 | 42.72 | 42.68 | 42.70 | 42.70 | 42.70 | 42.72 | 42.70 | 42.73 |
| Weight (g) | | 45.57 | 45.48 | 45.60 | 45.66 | 45.65 | 45.66 | 45.35 | 45.41 | 45.55 | 45.52 | 45.60 | 45.55 | 45.57 |
| Compression | | 60 | 62 | 69 | 70 | 58 | 59 | 88 | 89 | 91 | 79 | 53 | 101 | 48 |
| (Atti) | | | | | | | | | | | | | | |
| Surface | Shore C | 84 | 84 | 88 | 88 | 84 | 84 | 88 | 88 | 88 | 84 | 84 | 88 | 84 |
| hardness | Shore D | 58 | 58 | 60 | 60 | 58 | 58 | 61 | 61 | 61 | 58 | 58 | 61 | 58 |

| | | | | | | | | | | | | | |
|---|---|---|---|---|---|---|---|---|---|---|---|---|---|
| Intermediate layer | 13 | 14 | 9 | 9 | 13 | 13 | 10 | 10 | 10 | 14 | 13 | 10 | 13 |
| surface hardness − | | | | | | | | | | | | | |
| Ball surface hardness | | | | | | | | | | | | | |
| (Shore C) | | | | | | | | | | | | | |
| Shore C hardness | 2.5 | 2.5 | 2.2 | 2.1 | 2.5 | 2.2 | 4.4 | 3.1 | 3.8 | 3.3 | 2.8 | 2.7 | 2.9 |
| at surface of | | | | | | | | | | | | | |
| intermediate | | | | | | | | | | | | | |
| layer-encased sphere/ | | | | | | | | | | | | | |
| [(H100 − H0) × | | | | | | | | | | | | | |
| Intermediate layer | | | | | | | | | | | | | |
| thickness (mm)] | | | | | | | | | | | | | |
| Shore C hardness at | 3.8 | 3.8 | 3.4 | 3.1 | 3.8 | 3.4 | 5.3 | 3.8 | 4.6 | 4.0 | 3.4 | 4.6 | 4.3 |
| surface of | | | | | | | | | | | | | |
| intermediate | | | | | | | | | | | | | |
| layer-encased | | | | | | | | | | | | | |
| sphere/(H100 − H0) | | | | | | | | | | | | | |
| (Ball compression)/ | 3.5 | 3.6 | 2.3 | 2.3 | 3.4 | 3.0 | 1.2 | 1.3 | 1.2 | 1.4 | 2.7 | 1.4 | 3.7 |
| (Core compression) | | | | | | | | | | | | | |
| (Ball compression) − | 43 | 45 | 39 | 40 | 41 | 39 | 17 | 20 | 17 | 22 | 33 | 27 | 35 |
| (Core compression) | | | | | | | | | | | | | |
| Specific gravity | | | | | | | | | | | | | |
| relationships | | | | | | | | | | | | | |
| Specific gravity | 0.04 | 0.04 | 0.25 | 0.25 | 0.25 | 0.25 | 0.21 | 0.21 | 0.22 | 0.21 | 0.24 | 0.23 | 0.04 |
| of core − | | | | | | | | | | | | | |
| Specific gravity | | | | | | | | | | | | | |
| of intermediate | | | | | | | | | | | | | |
| layer material | | | | | | | | | | | | | |
| Specific gravity | 0.01 | 0.01 | 0.17 | 0.17 | 0.17 | 0.17 | 0.13 | 0.13 | 0.13 | 0.15 | 0.17 | 0.13 | 0.01 |
| of cover | | | | | | | | | | | | | |
| material − | | | | | | | | | | | | | |
| Specific | | | | | | | | | | | | | |
| gravity of | | | | | | | | | | | | | |
| intermediate | | | | | | | | | | | | | |
| layer material | | | | | | | | | | | | | |
| Specific gravity | 0.03 | 0.03 | 0.08 | 0.08 | 0.08 | 0.08 | 0.08 | 0.08 | 0.09 | 0.06 | 0.07 | 0.10 | 0.03 |
| of core − | | | | | | | | | | | | | |
| Specific | | | | | | | | | | | | | |
| gravity of | | | | | | | | | | | | | |
| cover material | | | | | | | | | | | | | |

The flight performances (I #6), spin rate on approach shots, feel and durability to repeated impact of each golf ball are evaluated by the following methods. The results are shown in Table 7.

Flight on Iron Shots

A number six iron (I #6) is mounted on a golf swing robot and the distance traveled by the ball when struck at a head speed of 43.5 m/s is measured. The club used is the JGR Forged (2016 model) manufactured by Bridgestone Sports Co., Ltd. The spin rate of the ball immediately after being similarly struck is measured with a launch monitor.

### Rating Criteria

Exc: Total distance is 181.0 m or more
Good: Total distance is at least 178.0 m and up to 180.9 m
NG: Total distance is less than 178.0 mm

Evaluation of Spin Rate on Approach Shots

A sand wedge (SW) is mounted on a golf swing robot and the spin rate of the ball when struck at a head speed of 15 m/s is rated according to the criteria shown below. The spin rate of the ball immediately after being similarly struck is measured with a launch monitor. The sand wedge used is the TourStage TW-03 (loft angle, 57°), 2002 model, manufactured by Bridgestone Sports Co., Ltd.

Rating Criteria:
Good: Spin rate is 4,500 rpm or more
NG: Spin rate is less than 4,500 rpm

Feel

The ball is hit by twenty amateur golfers having a handicap of 12 or less, and the feel of the ball is rated based on the number of golfers who judged the ball to have a “very soft and good feel” when hit.

Rating Criteria:
Exc: 18 or more of 20 golfers
Good: from 15 to 17 of 20 golfers
Fair: from 10 to 14 of 20 golfers
NG: 9 or fewer of 20 golfers

Durability to Repeated Impact

A test is performed in which, when a golf ball is fired at a velocity of 43 m/s and made to repeatedly strike a steel plate, the number of shots until the ball cracks is observed. N=30 sample balls are repeatedly struck in this way and the minimum number of shots after which the balls begin to crack is evaluated. Durability indices for the balls in the respective examples are calculated relative to an arbitrary value of 100 for the number of shots needed for the ball in Example 2 to crack.

Rating Criteria:
Good: Index is 90 or more
NG: Index is less than 90

TABLE 7

| | | Example | | | | | | Comparative Example | | | | | | |
|---|---|---|---|---|---|---|---|---|---|---|---|---|---|---|
| | | 1 | 2 | 3 | 4 | 5 | 6 | 1 | 2 | 3 | 4 | 5 | 6 | 7 |
| Flight on | Spin rate | 4,794 | 4,747 | 4,666 | 4,731 | 4,656 | 4,745 | 5,481 | 5,335 | 5,564 | 5,565 | 4,507 | 5,828 | 4,827 |
| iron (I#6) | (rpm) | | | | | | | | | | | | | |
| shots | Total | 180.9 | 181.2 | 180.5 | 179.8 | 182.6 | 181.9 | 175.4 | 175.3 | 175.6 | 172.4 | 184.1 | 173.0 | 180.6 |
| HS = | distance | | | | | | | | | | | | | |
| 43.5 m/s | (m) | | | | | | | | | | | | | |
| | Rating | Good | Exc | Good | Good | Exc | Exc | NG | NG | NG | NG | Exc | NG | Good |
| Approach | Spin rate | 4,986 | 4,953 | 4,807 | 4,837 | 4,970 | 4,968 | 5,044 | 5,043 | 5,098 | 5,237 | 4,903 | 5,191 | 4,976 |
| shots (SW) | (rpm) | | | | | | | | | | | | | |
| HS = | Rating | Good | Good | Good | Good | Good | Good | Good | Good | Good | Good | Good | Good | Good |
| 15 m/s | | | | | | | | | | | | | | |
| Feel | Rating | Exc | Exc | Good | Good | Exc | Exc | NG | NG | NG | Fair | Exc | NG | Exc |
| at impact | | | | | | | | | | | | | | |
| Durability | Rating | Good | Good | Good | Good | Good | Good | Good | Good | Good | Good | NG | Good | NG |
| to repeated | | | | | | | | | | | | | | |
| impact | | | | | | | | | | | | | | |

As demonstrated by the results in Table 7, the golf balls of Comparative Examples 1 to 7 are inferior in the following respects to the golf balls according to the present invention that are obtained in Examples 1 to 6.

In Comparative Example 1, the Atti compression of the core is larger than 38, the value of (Atti compression of core)/(Shore C hardness at core surface−Shore C hardness at core center) is larger than 1.1, and the value of (Shore C hardness at surface of intermediate layer-encased sphere)×(specific gravity of intermediate layer material)×(volume of intermediate layer material) is smaller than 600. As a result, the distance traveled by the ball on full shots with an iron is poor and a soft feel is not obtained.

In Comparative Example 2, the Atti compression of the core is larger than 38, the value of (Atti compression of core)/(Shore C hardness at core surface−Shore C hardness at core center) is larger than 1.1, and the value of (Shore C hardness at surface of intermediate layer-encased sphere)×(specific gravity of intermediate layer material)×(volume of intermediate layer material) is smaller than 600. As a result, the distance traveled by the ball on full shots with an iron is poor and a soft feel is not obtained.

In Comparative Example 3, the Atti compression of the core is larger than 38, the value of (Atti compression of core)/(Shore C hardness at core surface−Shore C hardness at core center) is larger than 1.1, and the value of (Shore C hardness at surface of intermediate layer-encased sphere)×(specific gravity of intermediate layer material)×(volume of intermediate layer material) is smaller than 600. As a result, the distance traveled by the ball on full shots with an iron is poor and a soft feel is not obtained.

In Comparative Example 4, the Atti compression of the core is larger than 38, the value of (Atti compression of core)/(Shore C hardness at core surface−Shore C hardness at core center) is larger than 1.1, and the value of (Shore C hardness at surface of intermediate layer-encased sphere)×(specific gravity of intermediate layer material)×(volume of intermediate layer material) is smaller than 600. As a result, the distance traveled by the ball on full shots with an iron is poor and a soft feel is not obtained.

In Comparative Example 5, the value of (Shore C hardness at surface of intermediate layer-encased sphere)×(specific gravity of intermediate layer material)×(volume of intermediate layer material) is smaller than 600. As a result, the durability of the ball to cracking on repeated impact is poor.

In Comparative Example 6, the Atti compression of the core is larger than 38 and the value of (Atti compression of core)/(Shore C hardness at core surface−Shore C hardness at core center) is larger than 1.1. As a result, the distance traveled by the ball on full shots with an iron is poor and a soft feel is not obtained.

In Comparative Example 7, the Atti compression of the core is smaller than 14. As a result, the durability of the ball to cracking on repeated impact is poor.

Japanese Patent Application No. 2022-086059 is incorporated herein by reference. Although some preferred embodiments have been described, many modifications and variations may be made thereto in light of the above teachings. It is therefore to be understood that the invention may be practiced otherwise than as specifically described without departing from the scope of the appended claims.

1. A golf ball comprising a single-layer rubber core, a single-layer resin cover and one intermediate layer interposed between the core and the cover, wherein the sphere obtained by encasing the core with the intermediate layer (intermediate layer-encased sphere) and the ball have a surface hardness relationship therebetween which satisfies the condition:
(Shore C hardness at surface of intermediate layer-encased sphere)>(Shore C hardness at surface of ball); and the ball satisfies the following three conditions:
14≤(Atti compression of core)≤38,
(Atti compression of core)/(Shore C hardness at core surface−Shore C hardness at core center)≤1.1, and
600≤(Shore C hardness at surface of intermediate layer-encased sphere)×(specific gravity of intermediate layer material)×[volume (cm³) of intermediate layer material].

2. The golf ball of claim 1, wherein the ball has a core hardness profile which, letting H100 be the Shore C hardness at the core surface, H87.5 be the Shore C hardness at a position 87.5% of the core radius outward from the core center, H75 be the Shore C hardness at a position 75% of the core radius outward from the core center, H50 be the Shore C hardness at a position 50% of the core radius outward from the core center, and H0 be the Shore C hardness at the core center, satisfies the condition:
(H100−H0)≥24.

3. The golf ball of claim 2, wherein the core hardness profile satisfies the condition:
(H100−H0)/(H50−H0)≤3.0.

4. The golf ball of claim 2, wherein the core hardness profile satisfies the condition:
(H87.5−H75)−(H100−H87.5)≥−0.5.

5. The golf ball of claim 1, wherein the core is a material molded under heat from a rubber composition comprising:
(A) a base rubber,
(B) an organic peroxide,
(C) water or a metal monocarboxylate or both, and
(D) sulfur.

6. The golf ball of claim 5, wherein components (C) and (D) have a weight ratio (D)/(C) therebetween which is from 0.010 to 0.200.

7. The golf ball of claim 1, wherein the ball satisfies the following three conditions:
−0.10≤(specific gravity of core)−(specific gravity of intermediate layer material)≤0.10
−0.10≤(specific gravity of cover material)−(specific gravity of intermediate layer material)≤0.10
−0.10≤(specific gravity of core)−(specific gravity of cover material)≤0.10

8. The golf ball of claim 1, wherein the specific gravity of the intermediate layer material is 1.05 or more.

9. The golf ball of claim 1, wherein the intermediate layer material includes a granular inorganic filler.

10. The golf ball of claim 1, wherein the ball satisfies the condition:
(Shore C hardness at surface of intermediate layer-encased sphere)/{(Shore C hardness at core surface−Shore C hardness at core center)×intermediate layer thickness (mm)}≤2.7.

11. The golf ball of claim 1 wherein, letting CL1 be the coefficient of lift measured at a Reynolds number of 80,000 and a spin rate of 2,000 rpm and CL2 be the coefficient of lift measured at a Reynolds number of 70,000 and a spin rate of 1,900, CL1 and CL2 satisfy the condition:
CL2≤/CL1.

12. The golf ball of claim 1 wherein, letting CL3 be the coefficient of lift measured at a Reynolds number of 200,000 and a spin rate of 2,500 rpm and CL4 be the coefficient of lift measured at a Reynolds number of 120,000 and a spin rate of 2,250, CL3 and CL4 satisfy the condition:
1.250≤CL4/CL3≤1.300.
